(19) United States
(12) Patent Application Publication
(10) Pub. No.: US 2021/0153031 A1
(43) Pub. Date: May 20, 2021

(54) COMMUNICATION MANAGEMENT DEVICE, COMMUNICATION DEVICE, COMMUNICATION MANAGEMENT METHOD, AND COMMUNICATION METHOD

(71) Applicant: SONY CORPORATION, TOKYO (JP)

(72) Inventors: SHIGERU SUGAYA, TOKYO (JP); YUICHI MORIOKA, TOKYO (JP)

(21) Appl. No.: 17/250,311

(22) PCT Filed: Jun. 27, 2019
(86) PCT No.: PCT/JP2019/025743

§ 371 Date: Dec. 31, 2020

(30) Foreign Application Priority Data
Jul. 11, 2018 (JP) 2018-131794

(51) Int. Cl. H04W 16/14; H04W 72/08; H04W 72/04; H04W 4/80; H04L 27/26

(52) U.S. Cl. CPC H04W 16/14; H04W 72/082; H04W 84/12; H04W 4/80; H04L 27/26025; H04W 72/0453

(57) ABSTRACT

A communication management device (10) includes: an acquisition unit (151) that acquires interference signal detection information with a narrow bandwidth narrower than a channel width defined in a predetermined frequency band, as a unit of detection; and a management unit (153) that manages, in units of narrow bandwidth, one or more frequency channels included in the predetermined frequency band as radio resources to be used by one or more communication devices for radio communication, based on the detection information.

### FIELD

The present disclosure relates to a communication management device, a communication device, a communication management method, and a communication method.

### BACKGROUND

Conventionally, radio waves are used in units of frequency channel. For example, a wireless local area network (LAN) communication method prescribed in IEEE802.11a uses radio waves in units of 20 MHz bandwidth channel. In order to make effective use of radio resources (radio wave resources), a communication device uses a frequency channel not being used by other communication devices.

### CITATION LIST

### Patent Literature

Patent Literature 1: JP 2011-015048 A

Patent Literature 2: JP 2015-095838 A

Patent Literature 3: JP 2007-312114 A

### SUMMARY

### Technical Problem

However, it is not possible to ensure effective use of radio resources (radio wave resources) simply by using a frequency channel that is not being used by other communication devices. For example, there have been emerging technologies, in recent years, that enable other radio communication systems to use the frequency bands used by an existing radio communication system. In this case, it is not possible to ensure that other radio communication systems use the radio resources in units of channel used by the existing radio communication system, leading to an assumable case where the radio resources are not used efficiently. It is not easy to use radio resources efficiently in the presence of various radio communication systems.

In view of this circumstance, the present disclosure proposes a communication management device, a communication device, a communication management method, and a communication method capable of effectively using radio resources.

### Solution to Problem

To solve the above problems, a communication management device according to an embodiment includes: an acquisition unit that acquires interference signal detection information with a narrow bandwidth narrower than a channel width defined in a predetermined frequency band, as a unit of detection; and a management unit that manages, in units of narrow bandwidth, one or more frequency channels included in the predetermined frequency band as radio resources to be used by one or more communication devices for radio communication, based on the detection information.

### Advantageous Effects of Invention

According to the present disclosure, it is possible to achieve effective use of radio resources. Note that the effects described herein are not necessarily limited and may be any of the effects described in the present disclosure.

### BRIEF DESCRIPTION OF DRAWINGS

FIG. 1 is a diagram illustrating a configuration example of a communication system according to an embodiment of the present disclosure.

FIG. 2 is a sequence diagram illustrating an outline of operation of a communication system according to an embodiment of the present disclosure.

FIG. 3 is a diagram illustrating a configuration example of a communication management device according to an embodiment of the present disclosure.

FIG. 4 is a diagram illustrating a configuration example of a communication device according to an embodiment of the present disclosure.

FIG. 5 is a diagram illustrating an example of channel arrangement in a predetermined frequency band.

FIG. 6 is a diagram illustrating subcarriers.

FIG. 7 is a diagram illustrating a configuration example of a resource unit used in a communication system of the present embodiment.

FIG. 8 is a diagram illustrating a bit arrangement for identifying a resource unit in use.

FIG. 9 is a diagram illustrating a usage status of a transmission line in a communication system that uses radio waves in units of frequency channel.

FIG. 10 is a diagram illustrating a usage status of a transmission line in a communication system that uses radio waves in units of frequency channel.

FIG. 11 is a diagram illustrating an execution example of uplink multi-user multiplexing.

FIG. 12 is a diagram illustrating an example of resource unit allocation in downlink multi-user multiplex communication.

FIG. 13 is a diagram illustrating a modification of resource unit allocation in downlink multi-user multiplex communication.

FIG. 14 is a diagram illustrating a modification of resource unit allocation in downlink multi-user multiplex communication.

FIG. 15 is a diagram illustrating a modification of resource unit allocation in downlink multi-user multiplex communication.

FIG. 16 is a diagram illustrating an example of resource unit allocation in uplink multi-user multiplex communication.

FIG. 17 is a diagram illustrating a modification of resource unit allocation in uplink multi-user multiplex communication.

FIG. 18 is a diagram illustrating a modification of resource unit allocation in uplink multi-user multiplex communication.

FIG. 19 is a diagram illustrating a modification of resource unit allocation in uplink multi-user multiplex communication.

FIG. 20 is a diagram illustrating a configuration example of a basic frame.

FIG. 21 is a diagram illustrating information elements described in a request frame of a report.

FIG. 22 is a diagram illustrating a modification of an information element described in a request frame of a report.

FIG. 23 is a diagram illustrating individual parameters included in a request frame of a report.

FIG. 24 is a diagram illustrating an example of an interference signal detection method.

FIG. 25 is a diagram illustrating a configuration example of an information element described in a report frame.

FIG. 26 is a diagram illustrating a modification of an information element described in a report frame.

FIG. 27 is a diagram illustrating a configuration example of a trigger frame.

FIG. 28 is a diagram illustrating a configuration example of a downlink OFDMA header.

FIG. 29 is a diagram illustrating an example of an arrangement mode of a communication system.

FIG. 30 is a sequence diagram illustrating an example of operation of a communication system in an arrangement mode illustrated in FIG. 29.

FIG. 31 is a diagram illustrating an example of an arrangement mode of a communication system.

FIG. 32 is a sequence diagram illustrating an example of operation of a communication system in the arrangement mode illustrated in FIG. 31.

FIG. 33 is a sequence diagram illustrating an example of operation of the communication system in the arrangement mode illustrated in FIG. 31.

FIG. 34 is a diagram illustrating an example of an arrangement mode of a communication system.

FIG. 35 is a sequence diagram illustrating an example of operation of a communication system in the arrangement mode illustrated in FIG. 34.

FIG. 36 is a diagram illustrating an example of an arrangement mode of a communication system.

FIG. 37 is a sequence diagram illustrating an example of operation of a communication system in the arrangement mode illustrated in FIG. 36.

FIG. 38 is a sequence diagram illustrating an example of operation of a communication system in the arrangement mode illustrated in FIG. 36.

FIG. 39 is a flowchart illustrating an example of reporting process according to an embodiment of the present disclosure.

FIG. 40 is a flowchart illustrating an example of a narrow-band signal detection process according to an embodiment of the present disclosure.

FIG. 41 is a flowchart illustrating an example of a report transmission process according to an embodiment of the present disclosure.

FIG. 42 is a flowchart illustrating an example of reporting receipt process according to an embodiment of the present disclosure.

FIG. 43 is a flowchart illustrating an example of a report reception process according to an embodiment of the present disclosure.

FIG. 44 is a flowchart illustrating an example of a communication process (communication management device side) according to an embodiment of the present disclosure.

FIG. 45 is a flowchart illustrating an example of a resource management process according to an embodiment of the present disclosure.

FIG. 46 is a flowchart illustrating an example of a resource construction process according to an embodiment of the present disclosure.

FIG. 47 is a flowchart illustrating an example of a communication process (communication device side) according to an embodiment of the present disclosure.

FIG. 48 is a flowchart illustrating an example of a transmission resource setting process according to an embodiment of the present disclosure.

FIG. 49 is a diagram illustrating a device configuration example of an information processing device which is an example of a communication management device according to an embodiment of the present disclosure.

FIG. 50 is a diagram illustrating a functional configuration example of an information processing device according to an embodiment of the present disclosure.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Moreover, in the present specification and the drawings, a plurality of components having substantially the same functional configuration will be distinguished by attaching different numbers after the same reference numerals. For example, a plurality of configurations having substantially the same functional configuration are distinguished as necessary, such as communication devices 20₁ and 20₂. However, when it is not particularly necessary to distinguish between the plurality of components having substantially the same functional configuration, only the same reference numeral is given. For example, when it is not necessary to distinguish between the communication devices 20₁ and 20₂, they are simply referred to as the communication device 20.

The present disclosure will be described in the following order.

1. Introduction

1-1. Usage of frequency bands used by existing communication systems

1-2. Radio communication using narrow-band signals

1-3. Coexistence with other communication systems that output narrow-band signals

1-4. Outline of processing

2. Configuration of communication system

2-1. Overall configuration of communication system

2-2. Configuration of communication management device

2-3. Configuration of communication device

3. Radio communication with a narrow bandwidth resource unit as unit of communication

3-1. Frequency channel

3-2. Subcarrier

3-3. Narrow bandwidth resource unit

3-4. Example of radio communication with a narrow bandwidth resource unit as unit of communication

4. Resource unit allocation example

4-1. Downlink allocation example

4-2. Uplink allocation example

5. Frame configuration

5-1. Basic Frame

5-2. Request Frame

5-3. Busy RU Report Frame

5-4. Trigger Frame

5-5. DL OFDMA Header

6. Communication system arrangement mode

6-1. Arrangement mode 1 (downlink)

6-2. Arrangement mode 2 (uplink)

6-3. Arrangement mode 3 (uplink)

6-4. Arrangement mode 4 (uplink)

7. Operation of communication system

7-1. Reporting process

7-2. Reporting receipt process

7-3. Communication process (communication management device side)

7-4. Communication process (communication device side)

8. Modifications

8-1. Modifications of configuration of communication management device

8-2. Other modifications

9. Conclusion

### 1. Introduction

A radio communication system (hereinafter referred to as a communication system) uses radio waves in units of frequency channel (hereinafter, simply referred to as a channel). For example, a wireless LAN system such as IEEE802.11a/11g/11n/11ac that uses orthogonal frequency-division multiplexing (OFDM) uses radio waves for each of 20 MHz bandwidth channels.

<1-1. Usage of Frequency Bands Used by Existing Communication Systems>

There have been emerging technologies, in recent years, that enable other communication systems to use the frequency bands (for example, unlicensed bands) used by existing communication systems. For example, the emerging technologies include one that allows other communication systems to use the frequency band (for example, the 5 GHz band) used by wireless LAN systems. One of these technologies is listen before talk (LBT). LBT is a technology that starts transmission of radio waves after confirming that there is no signal on the radio transmission line. An example of LBT is carrier sense multiple access/collision avoidance (CSMA/CA).

CSMA/CA is an access method that is also used in the communication procedure of IEEE 802.11-based wireless LAN systems. This method is one of contention methods (CSMA methods) in which data transmission rights are acquired in competition (first come, first served). In addition, CSMA/CA is one of the autonomous decentralized access methods that need no centralized management of radio control stations (also referred to as radio network controllers (RNCs)).

Other communication systems utilize this mechanism referred to as LBT to transmit a signal having a format different from the signal used by an existing communication system (for example, a signal having different signal format or frequency bandwidth) using a predetermined frequency band used by the existing communication system. Here, when the existing communication system is a wireless LAN system, the predetermined frequency band would be a 2.4 GHz band or a 5 GHz band, for example.

Specific examples of other communication systems include cellular communication systems such as long term evolution (LTE) and new radio (NR). For example, an LTE-based communication system (hereinafter referred to as the LTE system) uses technologies such as licensed-assisted access using LTE (LAA) to enable communication using the 5 GHz band used in a wireless LAN system.

<1-2. Radio Communication Using Narrow-Band Signals>

The bandwidths of the frequency channels defined in LTE are 1.4 MHz, 3 MHz, 5 MHz, 10 MHz, and 15 MHz, in addition to 20 MHz. That is, a communication system using LTE can transmit a signal having a bandwidth narrower than 20 MHz, which is recognized as a frequency channel by a wireless LAN system. Here is an assumable case where the LTE system uses a predetermined frequency band (for example, 5 GHz band) used by the wireless LAN system. In this case, signals having a bandwidth narrower than the bandwidth of the frequency channel used by the wireless LAN system (for example, 20 MHz) are mixed in the predetermined frequency band.

In the following description, a bandwidth narrower than the bandwidth of a frequency channel defined in a predetermined frequency band will be referred to as a narrow bandwidth. In the present embodiment, the “predetermined frequency band” indicates the 5 GHz band used by the wireless LAN system. Furthermore, the “bandwidth of the frequency channel defined in the predetermined frequency band” indicates 20 MHz used by the wireless LAN system, and the “narrow bandwidth” is a bandwidth narrower than 20 MHz. Needless to say, the “predetermined frequency band”, the “bandwidth of the frequency channel defined in the predetermined frequency band”, and the “narrow bandwidth” are not limited to this example. Furthermore, in the following description, a “narrow bandwidth signal” may be referred to as a narrow-band signal.

In recent years, the specifications of the physical layer have been updated as IEEE802.11ax. Similarly to IEEE 802.11a or the like, IEEE 802.11ax also adopts a multiple access method referred to as orthogonal frequency division multiple access (OFDMA) as a communication access method. In OFDMA, a frequency channel includes a plurality of subcarriers, and the density of subcarriers in IEEE802.11ax is four times that of the conventional IEEE802.11ac or the like. Specifically, the subcarrier spacing has been changed from the conventional 312.5 KHz to 78.125 KHz. In IEEE802.11ax, a resource unit (RU) having a narrower frequency bandwidth is defined in the conventional 20 MHz bandwidth channel. In IEEE802.11ax, a resource unit is a minimum unit of radio resources that can be allocated to a radio terminal. In other words, a wireless LAN system that uses IEEE802.11ax is capable of performing radio communication using narrow-band signals.

<1-3. Coexistence with Other Communication Systems that Output Narrow-Band Signals>

However, coexistence of a communication system (hereinafter referred to as a conventional communication system) that performs radio communication using a conventional bandwidth frequency channel (for example, a 20 MHz bandwidth frequency channel) as a single communication unit and a communication system (hereinafter, another or other communication system(s)) that outputs a narrower bandwidth signal in the same frequency band would lead to the following assumable problems.

(1) Concern of Failure in Detecting Other Communication System(s) by the Conventional Communication System

Conventional communication systems use a predetermined frequency band in units of frequency channel, and thus, detect the use status of radio waves of a predetermined frequency band in units of frequency channel. This would make it difficult to reliably detect the existence of other newly emerging communication systems. Even when a narrow-band signal is present, the conventional communication system would have a difficulty in reliably detecting the signal in a case where the channel is busy. That is, the conventional communication systems might fail to detect that the narrow band signal existing in a predetermined frequency band when another communication system that outputs a narrow-band signal exists in the surroundings. For example, when an LTE system uses narrow-band signals of 1.4 MHz, 3 MHz, and 5 MHz, a wireless LAN system that uses a frequency channel of 20 MHz as a minimum unit of communication might fail to detect the existence of the LTE system. In a case where the presence of another communication system cannot be detected, the conventional communication system might erroneously use the narrow-band used by the other communication system. In this case, both the conventional communication system and the other communication system fail in communication, resulting in waste of radio resources.

(2) Concern of Wasting Many Frequency Bands in the Frequency Channel

Even when the conventional communication system can detect the presence of another communication system, the conventional communication system cannot use the frequency channel that includes the narrow-band signal. Originally, a conventional communication system should be able to utilize a subcarrier not including a narrow-band signal even within one frequency channel. Nevertheless, the conventional communication system is configured to judge that the entire frequency channel is busy.

For example, here is an exemplary case where both the conventional communication system and another communication system are wireless LAN systems. At this time, when the conventional communication system detects a part of the resource unit used by an overlapping basic service set (overlapping BSS, or OBSS) that exists in an overlapping manner in the neighborhood of its own BSS, the system should set the entire frequency channel to busy even though it is possible to use the resource unit other than the detected resource unit. Therefore, even when the conventional communication system has successful in detecting the presence of another communication system, there is a concern of degradation of frequency utilization efficiency.

<1-4. Outline of Processing>

Therefore, in the present embodiment, the frequency bandwidth used for detecting that the transmission line is busy is set to a narrow bandwidth narrower than the bandwidth of the current frequency channel. For example, when the bandwidth of the current frequency channel is 20 MHz, the communication system detects an interference signal using a bandwidth narrower than 20 MHz, namely, bandwidth of 1 to 19 MHz, as a unit of detection. The narrow bandwidth may be a fixed width as long as it is narrower than the bandwidth of the frequency channel, or may be a width of a unit of communication (for example, resource unit) determined by a predetermined definition. For example, a communication system manages radio resources in units of narrow bandwidth resource unit. A resource unit is a minimum unit of resources that can be allocated. The resource unit may be a resource unit described in IEEE802.11ax or a resource block in a cellular communication system such as LTE or NR.

The communication system allocates a radio resources to a communication device in units of narrow bandwidth (for example, units of resource units having a narrow bandwidth) while avoiding the narrow bandwidth used by other communication systems. This makes it possible to efficiently use the radio resource while avoiding conflict even when other communication systems are using a predetermined frequency band in units of narrow bandwidth.

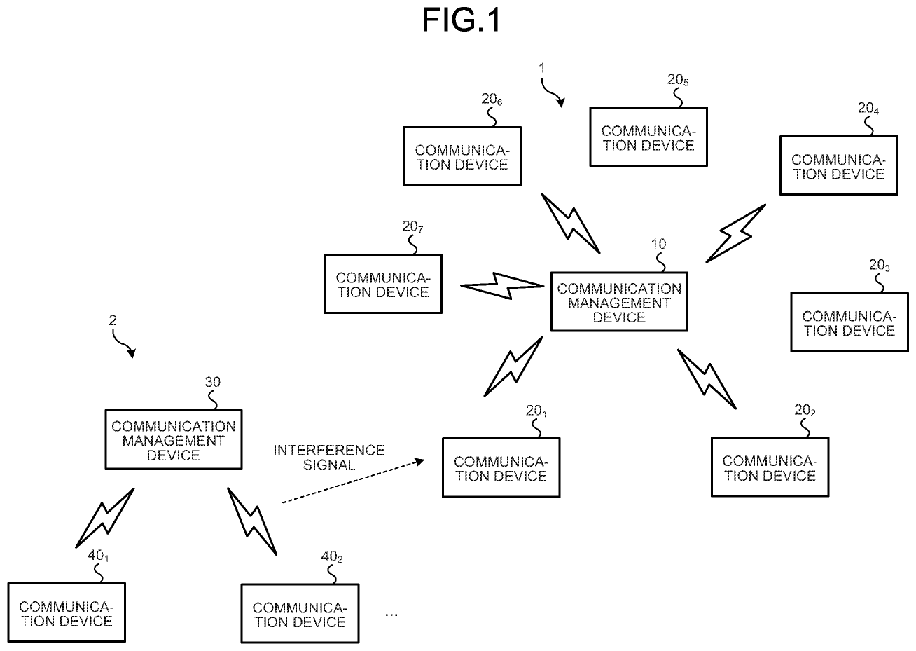

Hereinafter, an outline of processing executed by a communication system 1 of the present embodiment will be described. FIG. 1 is a diagram illustrating a configuration example of a communication system according to an embodiment of the present disclosure. The example of FIG. 1 illustrates the communication system 1 of the present embodiment and a communication system 2 existing in proximity to the communication system 1. In the present embodiment, the communication system 2 is another communication system. In the following description, another (other) communication system(s) may be simply referred to as another (other) system(s).

An example of the communication system 1 is a wireless LAN system described in IEEE802.11ax. Communication system 1 is capable of performing radio communication in units of narrow bandwidth resource unit. The communication system 1 includes a communication management device 10 and communication devices 20₁, 20₂, 20₃, 20₄, 20₅, 20₆, and 20₇. The communication management device 10 is an access point (AP), for example, and the communication device 20 is a wireless LAN terminal (station (STA)), for example. In the example of FIG. 1, the communication system 1 includes a single communication management device 10, but there may be a plurality of the communication management devices 10. Furthermore, while the example of FIG. 1 illustrates the communication system 1 including seven communication devices 20, the number of communication devices 20 may be more than seven or less than seven.

An example of the communication system 2 is an LTE system. Alternatively, the communication system 2 is a wireless LAN system described in IEEE 802.11ax. The communication system 2 is capable of outputting a narrow bandwidth signal. For example, in a case where the communication system 2 is an LTE system, the communication system 2 is capable of performing radio communication in units of narrow bandwidth resource block. Furthermore, in a case where the communication system 2 is an IEEE802.11ax wireless LAN system, the communication system 2 is capable of performing radio communication in units of narrow bandwidth resource unit.

The communication system 2 includes a communication management device 30 and communication devices 40₁ and 40₂. When the communication system 2 is an LTE system, the communication management device 30 is a base station (BS), and the communication device 40 is a terminal device (or user equipment (UE)), for example. When the communication system 2 is an IEEE802.11ax wireless LAN system, the communication management device 30 is an access point, and the communication device 40 is a wireless LAN terminal, for example. In the example of FIG. 1, the communication system 2 includes a single communication management device 30, but there may be a plurality of the communication management devices 30. Furthermore, while the example of FIG. 1 illustrates the communication system 2 including two communication devices 40, the number of communication devices 40 may be more than two or less than two.

In the example of FIG. 1, the communication device 20₁ of the communication system 1 detects a signal (arrow in the figure) transmitted by the communication device 40₂ of the communication system 2 to the communication management device 30 as a signal (dashed arrow) that is not intended to be received. In the following description, a signal that is not intended to be received is referred to as an interference signal. In this case, the communication device 20₁ can communicate with the communication management device 10 by executing the following procedure.

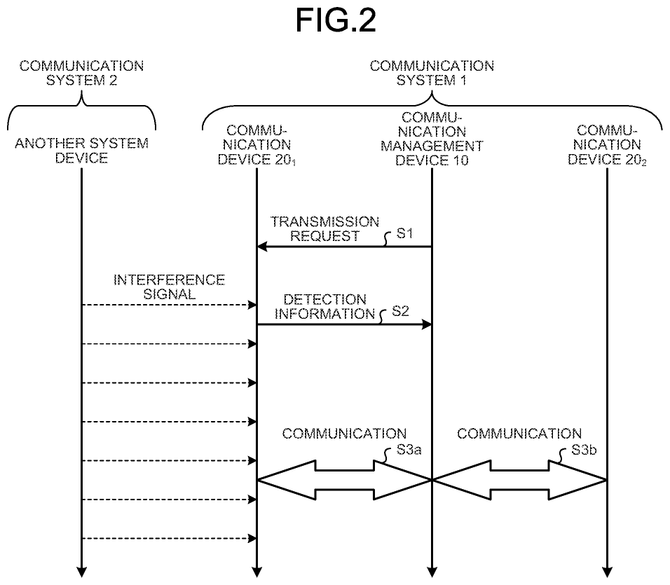

FIG. 2 is a sequence diagram illustrating an outline of an operation of the communication system 1 according to an embodiment of the present disclosure. The communication management device 10 requests the communication device 20₁ to transmit a report as needed in a case where a narrow-band signal (interference signal) has been detected (step S1). The report is information indicating that a narrow-band signal (interference signal) has been detected (hereinafter referred to as detection information). The communication management device 10 preliminarily transmits a request before the communication device 20₁ detects the narrow-band signal.

When the communication device 20₁ detects a narrow-band signal (interference signal) from a device of another communication system (hereinafter referred to as another system device), the communication device 20₁ transmits a report (detection information) to the communication management device (step S2). In the case of the example of FIG. 2, another system device is the communication device 40₂. The communication device 20₁ may transmit this report immediately after detecting the narrow-band signal. Alternatively, the communication device 20₁ may transmit this report when a predetermined reporting timing has arrived.

Based on the detection information, the communication management device 10 specifies a resource unit corresponding to the narrow-band in which the narrow-band signal has been detected. Subsequently, the communication management device 10 allocates a resource unit other than the specified resource unit to the communication device 20₁. Furthermore, the communication management device 10 allocates the specified resource unit to the communication device 20₂. Subsequently, the communication device 20₁ and the communication device 20₂ communicate with the communication management device 10 using the allocated resource unit (steps S3a and S3b).

With this configuration, the communication system 1 can efficiently use the radio resources even when the communication system 2 outputs a narrow-band signal.

### 2. Configuration of Communication System

Hereinafter, the communication system 1 according to an embodiment of the present disclosure will be described. The communication system 1 is a radio communication system that performs radio communication using a predetermined band. The predetermined frequency band may be an unlicensed band such as a 2.4 GHz band, a 5 GHz band, or a 60 GHz band. For example, the communication system 1 is a radio communication system that acquires radio resources of unlicensed bands by a contention method such as CSMA/CA. An example of the communication system 1 is a wireless LAN communication system described in IEEE802.11ax or the like. In a case where the communication system 1 is used as a wireless LAN communication system, the communication system 1 is not limited to the wireless LAN communication system described in IEEE 802.11ax. Communication system 1 may be a wireless LAN communication system conforming to a communication standard other than IEEE802.11ax, such as IEEE802.11a/11g/11n/11p/11ac/11ad/11af/ai.

The communication system 1 may also be a communication system that performs radio communication using a license band. For example, the communication system 1 may be a cellular communication system. The cellular communication system is not limited to LTE and NR, and may be other cellular communication systems such as wideband code division multiple access (W-CDMA) and code division multiple access 2000 (cdma2000), for example. In addition, “LTE” includes LTE-advanced (LTE-A), LTE-advanced pro (LTE-A Pro), and evolved universal terrestrial radio access (EUTRA). In addition, “NR” includes new radio access technology (NRAT) and further EUTRA (FEUTRA). Needless to say, even when the communication system 1 is a cellular communication system, the communication system 1 can be configured as a radio communication system that communicates using an unlicensed band.

Note that the communication system 1 is not limited to the wireless LAN communication system and the cellular communication system. For example, communication system 1 may be other radio communication systems such as a television broadcasting system, an aeronautical radio system, or a space radio communication system. The communication system 1 provides a radio service to a user or a device owned by the user by using a predetermined radio access technology such as a wireless LAN communication technology. The communication system 2 may have a configuration similar to the communication system 1. Alternatively, detection may be performed on signals from devices independent of the communication system, such as signals from radar communication devices using electromagnetic signals, positioning systems, and electronic cooking tools. The radio access technology (radio access method) can be paraphrased as the radio access control technology (radio access control method).

<2-1. Overall Configuration of Communication System>

The communication system 1 is a radio communication system that performs radio communication using a predetermined band. The predetermined frequency band is a 5 GHz band, for example. Although the following description assumes a predetermined frequency band of the 5 GHz band, the predetermined frequency band is not limited to the 5 GHz band. For example, the predetermined frequency band may be other unlicensed bands such as a 2.4 GHz band or a 60 GHz band. Note that the 5 GHz band may be the 5.2 GHz band (5180 MHz-5240 MHz) or the 5.3 GHz band (5260 MHz-5320 MHz). Furthermore, the 5 GHz band may be a 5.6 GHz band (5500 MHz-5700 MHz) or a 5.8 GHz band (5725 MHz-5850 MHz). In addition, the band may include a frequency band that can be newly used as an unlicensed band, and may be a frequency band that is usable as a secondary service as long as it does not affect the frequency band in which a primary service already exists.

As illustrated in FIG. 1, the communication system 1 includes the communication management device 10 and the communication device 20. The communication system 1 may include a plurality of the communication management devices 10 and a plurality of the communication devices 20, or may include only one of each. In the example of FIG. 1, the communication system 1 includes the communication management device 10 as the communication management device 10. Furthermore, the communication system 1 includes communication devices 20₁, 20₂, 20₃, 20₄, 20₅, 20₆, 20₇ or the like, as the communication device 20. The communication management device 30 in the communication system 2 may have a configuration similar to the communication management device 10. Furthermore, the communication device 40 included in the communication system 2 may have a configuration similar to the communication device 20.

The communication management device 10 is a device that manages (or controls) the communication of the communication device 20. Furthermore, the communication management device 10 is a radio communication device that performs radio communication with the communication device 20 or another communication management device 10. In the following description, a radio communication device may be simply referred to as a communication device. When the communication system 1 is a wireless LAN communication system, the communication management device 10 is a device that functions as an access point. The communication management device 10 may be a relay device that relays communication between communication devices. The communication management device 10 is not limited to the access point of the wireless LAN communication system, and may be a communication management device (communication control device) of another radio communication system such as a cellular communication system. In this case, the communication management device 10 can be paraphrased as a base station (also referred to as a base station device).

A base station conceptually includes an access point and a radio relay station (also referred to as a relay device). Furthermore, a base station conceptually includes not only a structure having a function of a base station but also a device installed in the structure. Examples of the structure include a building such as an office building, a house, a steel tower, a station facility, an airport facility, a port facility, or a stadium. A structure conceptually includes not only buildings but also non-building structures such as tunnels, bridges, dams, fences, steel columns, as well as facilities such as cranes, gates, and windmills. In addition, a structure conceptually includes not only aboveground (onshore)/underground structures but also structures on the water such as a jetty and a mega-float, and structures underwater such as an ocean observation facility.

Furthermore, the base station may be a mobile base station (mobile station). At this time, the base station (mobile station) may be a radio communication device installed in a mobile body, or may be the mobile body itself. The mobile body may be a mobile body that moves on the ground (land) (for example, a vehicle such as an automobile, a bus, a truck, a train, or a linear motor car), or a mobile body (for example, subway) that moves in the ground (for example, in a tunnel). Naturally, the mobile body may be a mobile terminal such as a smartphone. The mobile body may be a mobile body that moves on the water (for example, a ship such as a passenger ship, a cargo ship, and a hovercraft), or a mobile body that moves underwater (for example, a submersible boat, a submarine, an unmanned submarine, or the like). Furthermore, the mobile body may be a mobile body that moves in the atmosphere (for example, an aircraft such as an airplane, an airship, or a drone), or may be a space mobile body that moves outside the atmosphere (for example, an artificial astronomical object such as a satellite, a spaceship, a space station or a spacecraft).

The communication device 20 is a communication device having a communication function. The communication device 20 is a device having a wireless LAN communication function. The communication device 20 is a user terminal such as a mobile phone, a smart device (smartphone or tablet), a wearable terminal, a personal digital assistant (PDA), or a personal computer, for example. Furthermore, the communication device 20 may be a device other than the user terminal, such as a machine in a factory or a sensor installed in a building. For example, the communication device 20 may be a machine to machine (M2M) device or an internet of things (IoT) device. Furthermore, the communication device 20 may be a device having a relay communication function, represented by device to device (D2D). Furthermore, the communication device 20 may be a device referred to as client premises equipment (CPE) used in a radio backhaul or the like. Furthermore, the communication device 20 may be a radio communication device installed on a mobile body, or may be the mobile body itself.

Hereinafter, configurations of individual devices included in the communication system 1 will be specifically described.

<2-2. Configuration of Communication Management Device>

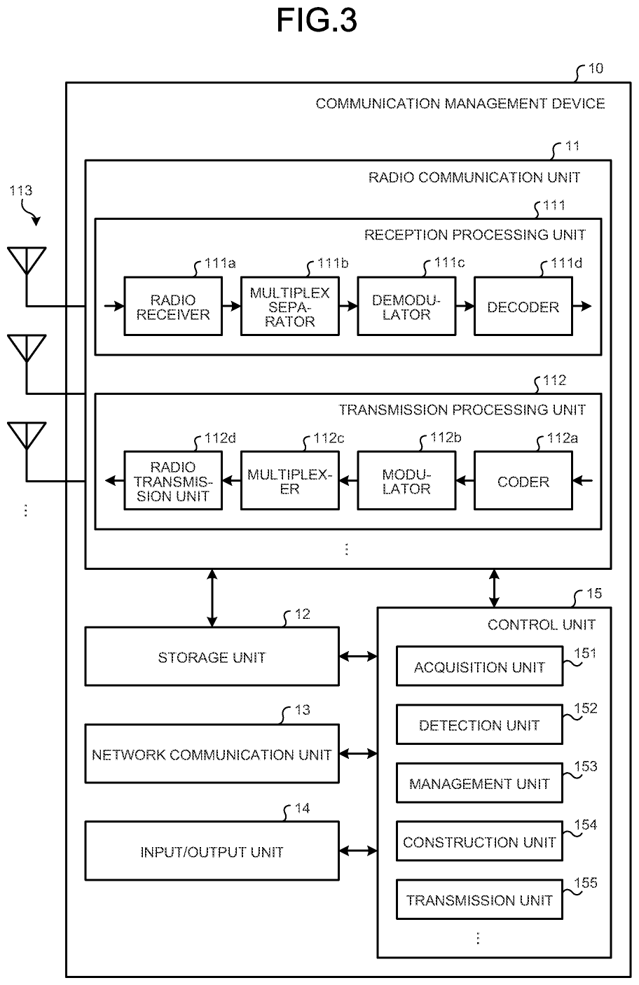

First, a configuration of the communication management device 10 will be described. FIG. 3 is a diagram illustrating a configuration example of the communication management device 10 according to an embodiment of the present disclosure. The communication management device 10 acquires detection information of the interference signal using a narrow bandwidth narrower than the channel width defined by a predetermined frequency band (for example, 5 GHz band) as a unit of detection. Subsequently, the communication management device 10 manages, in units of narrow bandwidth, one or more frequency channels included in a predetermined frequency band as radio resources to be used by the communication device 20 for radio communication. For example, based on detection information, the communication management device 10 manages frequency channels in units of narrow bandwidth resource unit.

The frequency channel is a frequency channel defined by a predetermined communication standard (for example, a wireless LAN standard such as IEEE802.11ax). For example, here is an exemplary case where the predetermined frequency band is the 5.2 GHz band (5180 MHz-5240 MHz). At this time, the frequency channels are, for example, 36ch, 40ch, 44ch, and 48ch. Furthermore, in another exemplary case, the predetermined frequency band is the 5.3 GHz band (5260 MHz-5320 MHz). At this time, the frequency channels are 52ch, 56ch, 60ch, and 64ch. Furthermore, in another exemplary case, the predetermined frequency band is the 5.6 GHz band (5500 MHz-5700 MHz). At this time, the frequency channels are, for example, 100ch, 104ch, 108ch, 112ch, 116ch, 120ch, 124ch, 128ch, 132ch, 136ch, 140ch. Furthermore, in another exemplary case, the predetermined frequency band is the 5.8 GHz band (5725 MHz-5850 MHz). At this time, the frequency channels are, for example, 149ch, 153ch, 157ch, 161ch, and 165ch. In the case of the 5 GHz band, the channel width (bandwidth per channel) is 20 MHz in each of cases.

A resource unit is a minimum unit of radio resources that can be allocated. The resource unit may be a resource unit in a wireless LAN system as described IEEE802.11ax or a resource block in a cellular communication system such as LTE or NR. In the following, the resource unit can indicate resource unit described in IEEE802.11ax. However, the resource unit is naturally not limited to the resource unit described in IEEE802.11ax. The resource units described below can be appropriately replaced with “minimum allocation unit”, “resource block”, or the like.

The communication management device 10 includes a radio communication unit 11, a storage unit 12, a network communication unit 13, an input/output unit 14, and a control unit 15. Note that the configuration illustrated in FIG. 3 is a functional configuration, and the hardware configuration may be different from this. Furthermore, the functions of the communication management device 10 may be distributed and implemented in a plurality of physically separated devices.

The radio communication unit 11 is a radio communication interface that performs radio communication with other communication devices (for example, the communication device 20 and the other communication management device 10). The radio communication unit 11 operates under the control of the control unit 25. The radio communication unit 11 may support a plurality of radio access methods. For example, the radio communication unit 11 may support both the wireless LAN communication method and the cellular communication method. Needless to say, the radio communication unit 11 may be configured to support a single radio access method. The radio communication unit 11 is capable of detecting an interference signal (narrow-band signal) using a narrow bandwidth narrower than the channel width (for example, 20 MHz width) defined in a predetermined frequency band (for example, 5 GHz band), as a unit of detection.

The radio communication unit 11 includes a reception processing unit 111, a transmission processing unit 112, and an antenna 113. The radio communication unit 11 may include a plurality of reception processing units 111, transmission processing units 112, and antennas 113, individually. In a case where the radio communication unit 11 supports a plurality of radio access methods, individual portions of the radio communication unit 11 can be configured separately for each of the radio access methods. For example, in a case where the communication management device 10 supports the wireless LAN communication method and the cellular communication method, the reception processing unit 111 and the transmission processing unit 112 are individually configured separately for each of the wireless LAN communication method and the cellular communication method.

The reception processing unit 111 processes an uplink signal received via the antenna 113. The reception processing unit 111 includes a radio receiver 111a, a multiplex separator 111b, a demodulator 111c, and a decoder 111d.

The radio receiver 111a performs processes on the uplink signal, such as down-conversion, removal of unnecessary frequency components, amplification level control, orthogonal demodulation, conversion to digital signal, removal of guard interval, and frequency domain signal extraction using fast Fourier transform. For example, the multiplex separator 111b separates the uplink channel and the uplink reference signal from the signal output from the radio receiver 111a. Using a modulation method such as binary phase shift keying (BPSK) or quadrature phase shift keying (QPSK) for the modulation symbol of the uplink channel, the demodulator 111c demodulates the received signal. The modulation method used by the demodulator 111c may be 16 quadrature amplitude modulation (QAM), 64 QAM, 256 QAM, or 1024 QAM. The decoder 111d performs a decoding process on the coded bits of the demodulated uplink channel. The decoded uplink data and uplink control information are output to the control unit 25.

The transmission processing unit 112 performs transmission processing of downlink control information and downlink data. The transmission processing unit 112 includes a coder 112a, a modulator 112b, a multiplexer 112c, and a radio transmission unit 112d.

The coder 112a encodes the downlink control information and the downlink data input from the control unit 15 by using a coding method such as block coding, convolutional coding, or turbo coding. The modulator 112b modulates the coding bits output from the coder 112a by a predetermined modulation method such as BPSK, QPSK, 16 QAM, 64 QAM, 256 QAM, or 1024 QAM. The multiplexer 112c multiplexes the modulation symbol of each of channels and the downlink reference signal and allocates the multiplexed signals on a predetermined resource element. The radio transmission unit 112d performs various signal processing on the signal from the multiplexer 112c. For example, the radio transmission unit 112d performs processes such as conversion to the time domain using fast Fourier transform, addition of a guard interval, generation of a baseband digital signal, conversion to an analog signal, quadrature modulation, upconvert, removal of extra frequency components, and power amplification. The signal generated by the transmission processing unit 112 is transmitted from the antenna 213.

The storage unit 12 is a data readable/writable storage device such as DRAM, SRAM, flash memory, and a hard disk. The storage unit 12 functions as a storage means for the communication management device 10. The storage unit 22 stores interference signal detection information or the like. The detection information is the detection information of the interference signal from another system detected by the communication device 20 or the communication management device 10 itself.

The network communication unit 13 is a communication interface for communicating with other devices. An example of the network communication unit 13 is a local area network (LAN) interface such as a (Network Interface Card). The network communication unit 13 is configured to be connected to a wired network as Ethernet (registered trademark), and can be connected as a bus via peripheral component interconnect (PCI) or connected using a network interface card (NIC) via an RJ-45 standard jack, or it may be a universal serial bus (USB) interface using a USB host controller and a USB port. Furthermore, the network communication unit 13 may be a wired interface or a wireless interface. The network communication unit 13 functions as a network communication means for the communication management device 10. The network communication unit 13 communicates with other devices under the control of the control unit 15.

The input/output unit 14 is a user interface for exchanging information with the user. For example, the input/output unit 14 is an operation device such as a keyboard, a mouse, operation keys, and a touch panel, used by a user to perform various operations. Alternatively, the input/output unit 14 is a display device such as a liquid crystal display, or an organic Electroluminescence (EL) display. The input/output unit 14 may be an acoustic device such as a speaker or a buzzer. Furthermore, the input/output unit 14 may be a lighting device such as a light emitting diode (LED) lamp. The input/output unit 14 functions as an input/output means (input means, output means, operation means, or notification means) provided on the communication management device 10.

The control unit 15 is a controller that controls individual components of the communication management device 10. The control unit 15 is actualized by a processor such as a central processing unit (CPU) or a micro processing unit (MPU). For example, the control unit 15 is actualized by execution of various programs stored in the storage device inside the communication management device 10 by the processor using random access memory (RAM) or the like as a work area. Note that the control unit 15 may be actualized by an integrated circuit such as an application specific integrated circuit (ASIC) or a field programmable gate array (FPGA). The CPU, MPU, ASIC, and FPGA can all be regarded as controllers.

As illustrated in FIG. 3, the control unit 15 includes an acquisition unit 151, a detection unit 152, a management unit 153, a construction unit 154, and a transmission unit 155. Individual blocks (acquisition unit 151 to transmission unit 155) constituting the control unit 15 are functional blocks individually indicating functions of the control unit 15. These functional blocks may be software blocks or hardware blocks. For example, each of the functional blocks described above may be one software module actualized by software (including a microprogram) or one circuit block on a semiconductor chip (die). Each of the functional blocks may of course be formed as one processor or one integrated circuit. The functional block may be configured by using any method. Note that the control unit 15 may be configured in a functional unit different from the above-described functional block. The operation of each block (acquisition unit 151 to transmission unit 155) constituting the control unit 15 will be described in detail in a description of communication control processing or the like described below.

<2-3. Configuration of Communication Device>

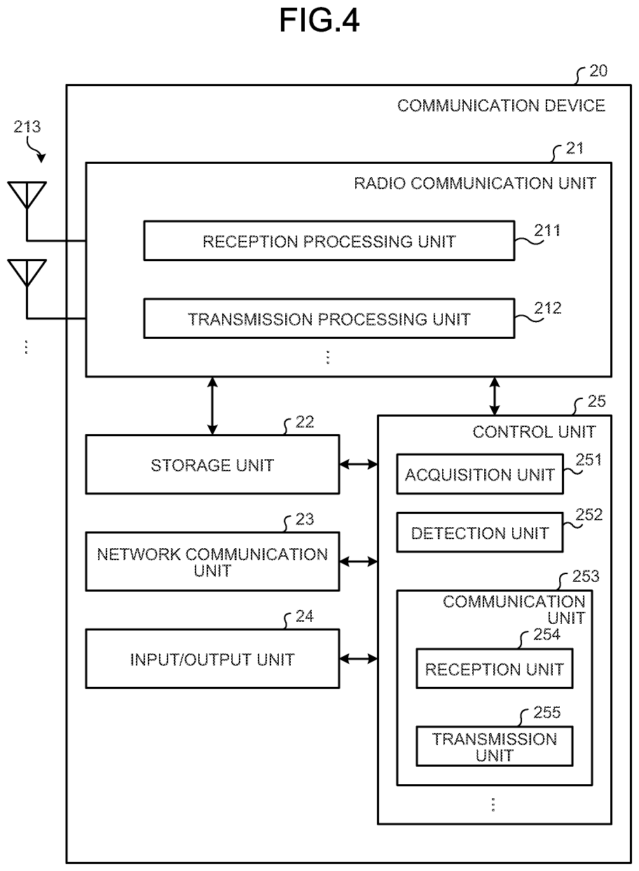

Next, a configuration of the communication device 20 will be described. FIG. 4 is a diagram illustrating a configuration example of the communication device 20 according to an embodiment of the present disclosure.

The communication device 20 includes a radio communication unit 21, a storage unit 22, a network communication unit 23, an input/output unit 24, and a control unit 25. Note that the configuration illustrated in FIG. 4 is a functional configuration, and the hardware configuration may be different from this. Furthermore, the functions of the communication device 20 may be distributed and implemented in a plurality of physically separated devices.

The radio communication unit 21 is a radio communication interface that performs radio communication with other communication devices (for example, the communication management device 10 or another communication device 20). The radio communication unit 21 operates under the control of the control unit 25. The radio communication unit 21 may support a plurality of radio access methods. For example, the radio communication unit 21 may support both the wireless LAN communication method and the cellular communication method. Needless to say, the radio communication unit 21 may be configured to support a single radio access method. The radio communication unit 21 is capable of detecting an interference signal (narrow-band signal) using a narrow bandwidth narrower than the channel width (for example, 20 MHz width) defined in a predetermined frequency band (for example, 5 GHz band), as a unit of detection.

The radio communication unit 21 includes a reception processing unit 211, a transmission processing unit 212, and an antenna 213. The radio communication unit 21 may include a plurality of reception processing units 211, transmission processing units 212, and antennas 213, individually. In a case where the radio communication unit 21 supports a plurality of radio access methods, individual portions of the radio communication unit 21 can be configured separately for each of the radio access methods. For example, in a case where the communication device 20 supports the wireless LAN communication method and the cellular communication method, the reception processing unit 211 and the transmission processing unit 212 may be individually configured separately for each of the wireless LAN communication method and the cellular communication method.

The reception processing unit 211 processes an uplink signal received via the antenna 213. In addition, the transmission processing unit 212 performs transmission processing of downlink control information and downlink data. The configuration of the reception processing unit 211 and the transmission processing unit 212 may respectively be the same as the configuration of the reception processing unit 111 and the transmission processing unit 112 of the communication management device 10.

The storage unit 22 is a data readable/writable storage device such as DRAM, SRAM, flash memory, and a hard disk. The storage unit 22 functions as a storage means for the communication device 20. The storage unit 22 stores interference signal detection information or the like. The detection information is the detection information of the interference signal from the communication device 20 or from another system detected by the communication device 20.

The network communication unit 23 is a communication interface for communicating with other devices. An example of the network communication unit 23 is a local area network (LAN) interface such as a (Network Interface Card). The network communication unit 23 is configured to be connected to a wired network as Ethernet, and can be connected as a bus via peripheral component interconnect (PCI) or connected using a network interface card (NIC) via an RJ-45 standard jack via NIC), or it may be a universal serial bus (USB) interface including a USB host controller and a USB port. Furthermore, the network communication unit 23 may be a wired interface or a wireless interface. The network communication unit 23 functions as a network communication means of the communication device 20. The network communication unit 23 communicates with other devices under the control of the control unit 25.

The input/output unit 24 is a user interface for exchanging information with the user. For example, the input/output unit 24 is an operation device such as a keyboard, a mouse, operation keys, and a touch panel, used by a user to perform various operations. Alternatively, the input/output unit 24 is a display device such as a liquid crystal display, or an organic Electroluminescence (EL) display. The input/output unit 24 may be an acoustic device such as a speaker or a buzzer. Furthermore, the input/output unit 24 may be a lighting device such as a light emitting diode (LED) lamp. The input/output unit 24 functions as an input/output means (input means, output means, operation means, or notification means) provided on the communication device 20.

The control unit 25 is a controller that controls individual components of the communication device 20. The control unit 25 is actualized by a processor such as a central processing unit (CPU) or a micro processing unit (MPU). For example, the control unit 25 is actualized by execution of various programs stored in the storage device inside the communication device 20 by the processor using random access memory (RAM) or the like as a work area. Note that the control unit 25 may be actualized by an integrated circuit such as an application specific integrated circuit (ASIC) or a field programmable gate array (FPGA). The CPU, MPU, ASIC, and FPGA can all be regarded as controllers.

As illustrated in FIG. 4, the control unit 25 includes an acquisition unit 251, a detection unit 252, a communication unit 253, a reception unit 254, and a transmission unit 255. Individual blocks (acquisition unit 251 to transmission unit 255) constituting the control unit 25 are functional blocks individually indicating functions of the control unit 25. These functional blocks may be software blocks or hardware blocks. For example, each of the functional blocks described above may be one software module actualized by software (including a microprogram) or one circuit block on a semiconductor chip (die). Each of the functional blocks may of course be formed as one processor or one integrated circuit. The functional block may be configured by using any method. Note that the control unit 25 may be configured in a functional unit different from the above-described functional block. The operation of each of blocks (acquisition unit 251 to transmission unit 255) constituting the control unit 25 will be described in detail in a description of communication control processing or the like described below.

### 3. Radio Communication with a Narrow Bandwidth Resource Unit as Unit of Communication

The communication management device 10 and the communication device 20 are capable of performing radio communication with a narrow bandwidth resource unit as a unit of communication. Before describing radio communication in which a resource unit having a narrow bandwidth is used as a unit of communication, the frequency channels used by the communication management device 10 and the communication device 20 will be described.

<3-1. Frequency Channel>

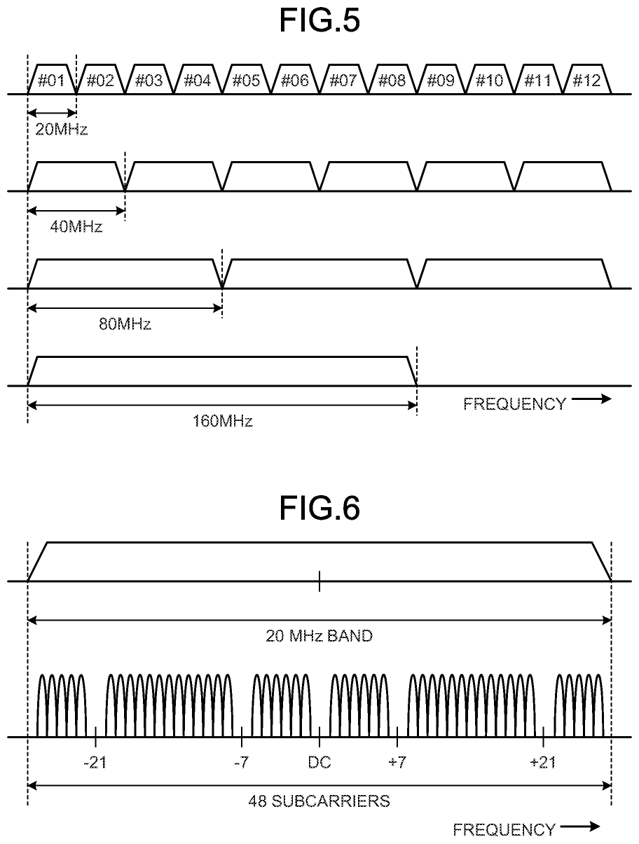

FIG. 5 is a diagram illustrating an example of frequency channel arrangement in a predetermined frequency band. Specifically, FIG. 5 is a diagram illustrating an example of frequency channel arrangement in an unlicensed band (for example, 5 GHz band) used by a wireless LAN system. Even though there are some variations in the usable frequency channels due to differences in the legal systems of individual countries, channels are generally used in the frequency arrangement illustrated in FIG. 5.

In FIG. 5, one trapezoid illustrated at the top of the illustration is a frequency channel. An example at the top of FIG. 5 illustrates arrangements of 12 channels, namely, channels #01 to #12. In an exemplary case where a predetermined frequency band is a 5 GHz band, the channels #01 to #12 correspond to 100ch, 104ch, 108ch, 112ch, 116ch, 120ch, 124ch, 128ch, 132ch, 136ch, 140ch, and 144ch, for example. The example at the top of FIG. 5 assumes that the frequency channel width of 20 MHz is used as one channel.

The communication system 1 can also use a frequency channel bonding technology using a plurality of channels grouped together. The second row in the figure is configured to use the frequency channel width of 40 MHz, the third row in the figure is configured to use the frequency channel width of 80 MHz, and the fourth row in the figure is configured to use the frequency channel width of 160 MHz. An appropriate channel width is used in accordance with the use capacity of the communication device and the availability of the radio transmission channel. The use of frequency channel bonding technology leads to improvement of transmission efficiency. In the conventional wireless LAN system, the minimum frequency bandwidth of 20 MHz is managed as a single frequency channel.

Note that the channel width is not limited to the channel width specified by the wireless LAN communication method (for example, 20 MHz). For example, the channel width may be a channel width defined by a predetermined communication method that defines radio communication using orthogonal frequency multiple access (OFDMA). The predetermined communication method is not limited to the wireless LAN communication method as described in IEEE802.11ax, and may be another communication method. Needless to say, the predetermined communication method may be a wireless LAN communication method other than one described in IEEE802.11ax.

<3-2. Subcarrier>

In OFDMA, the frequency channel includes a plurality of subcarriers. FIG. 6 is a diagram illustrating subcarriers. Specifically, FIG. 6 illustrates a frequency channel as defined in the conventional IEEE802.11ac or the like. In a conventional wireless LA system, the subcarrier spacing is 312.5 KHz, and one frequency channel includes 48 subcarriers. In contrast, the density of subcarriers in IEEE802.11ax is higher than that in conventional IEEE802.11ac or the like. Specifically, IEEE802.11ax uses the subcarrier spacing 78.125 KHz, which has been changed from the conventional 312.5 KHz. In addition, IEEE802.11ax defines a resource unit having a narrower frequency bandwidth (narrow bandwidth) in a conventional 20 MHz bandwidth channel.

Here, the narrow bandwidth may be a bandwidth corresponding to a predetermined number of subcarrier spacing defined in a predetermined communication method. For example, the narrow bandwidth may be a bandwidth of a predetermined number (for example, 26) of subcarrier spacings defined by a wireless LAN communication method described in IEEE802.11ax, or the like. The narrow bandwidth may naturally be a predetermined number of subcarrier spacings defined by a wireless LAN communication method other than IEEE802.11ax. Furthermore, the narrow bandwidth may be a predetermined number of subcarrier spacings defined by a communication method other than the wireless LAN communication method.

<3-3. Narrow Bandwidth Resource Unit>

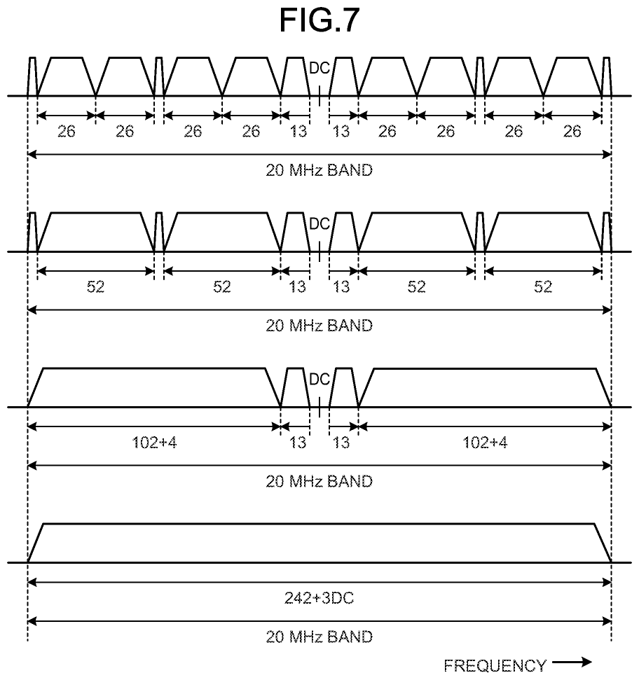

FIG. 7 is a diagram illustrating a configuration example of a resource unit used in the communication system 1 of the present embodiment. Specifically, FIG. 7 illustrates a multiplexing configuration in the frequency axis direction of the resource unit applied in IEEE802.11ax. In the example at the top of FIG. 7, one resource unit includes 26 narrowband subcarrier signals. This is a configuration including nine resource units in a 20 MHz bandwidth. Note that the fifth resource unit has a configuration in which the plurality of subcarriers is zero because of the necessity to set the center frequency to the DC subcarrier in order to maintain compatibility with the conventional wireless LAN system.

As illustrated in the second row in the figure, IEEE802.11ax has also prepared a configuration in which a resource unit includes 52 narrowband subcarrier signals. The central resource unit has 26 subcarriers to form one resource unit. Note that a guard of one subcarrier is provided between the individual resource units.

As illustrated in the third row in the figure, IEEE802.11ax has also prepared a configuration in which a resource unit includes 102 narrowband subcarrier signals. Furthermore, in IEEE802.11ax, as illustrated in the fourth row in the figure, it is possible to configure a large resource unit by using a narrowband subcarrier signal over almost the entire band.

In this manner, IEEE802.11ax has a configuration of performing multiplexing in which frequency resources are managed and allocated in units of resource unit.

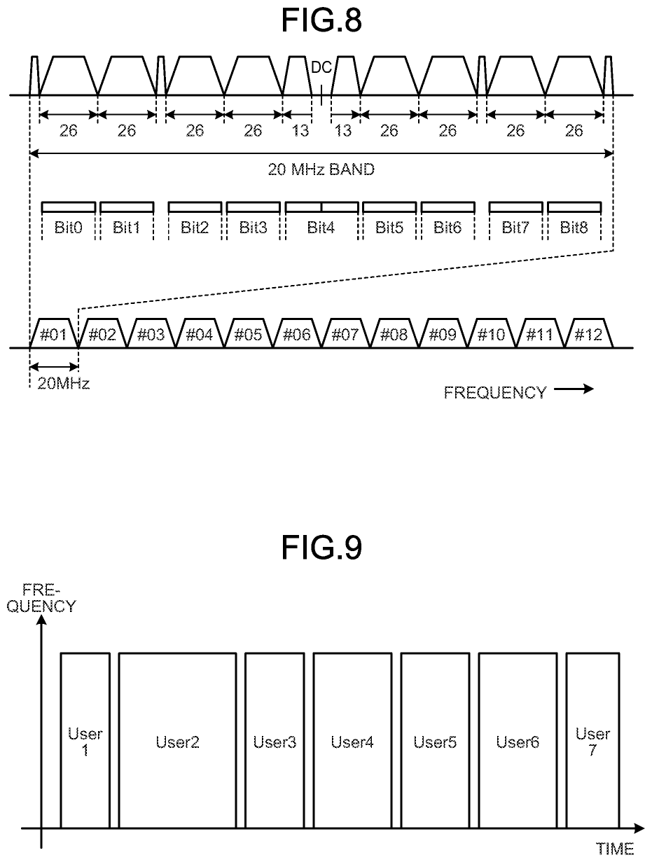

FIG. 8 is a diagram illustrating a bit arrangement for identifying the resource unit in use. The bits illustrated in FIG. 8 indicate in which resource unit the interference signal (narrow-band signal) is detected within the individual channel bandwidth of 20 MHz. In the example of FIG. 8, bits are allocated such that bit 0, bit 1, . . . , that is, in order from the one corresponding to the resource unit in the lower frequency. The most significant bit 9 corresponds to the resource unit in the highest frequency. Note that the bit arrangement is not limited to this arrangement. The arrangement in the 20 MHz frequency band is mapped to the entire frequency channel applied to the wireless LAN system.

The communication device 20 stores this bit information as interference signal detection information in a report frame and transmits this bit information to the communication management device 10. The detection information may be reported in a width corresponding to the frequency channel approved for use in the wireless LAN system in individual countries. Alternatively, the reporting may be limited to the frequency bandwidths (20 MHz, 40 MHz, 80 MHz, and 160 MHz) actually operating at the access point.

<3-4. Example of Radio Communication with a Narrow Bandwidth Resource Unit as Unit of Communication>

FIG. 9 is a diagram illustrating a usage status of a transmission line in a communication system that uses radio waves in units of frequency channel. Specifically, FIG. 9 is a diagram illustrating a usage status of a transmission line in a conventional wireless LAN system. In a wireless LAN system that uses radio waves in units of frequency channel, signals that use all 20 MHz channels are transmitted and received. The wireless LAN system that uses radio waves utilizes a frequency division multiplexing method in units of frequency channel in order to achieve coexistence of a plurality of users. Therefore, a predetermined interframe space is allocated before each of users starts using the system. In this method, the occupied time of the transmission line varies according to the needs of individual users, making it possible to achieve a simple communication control method.

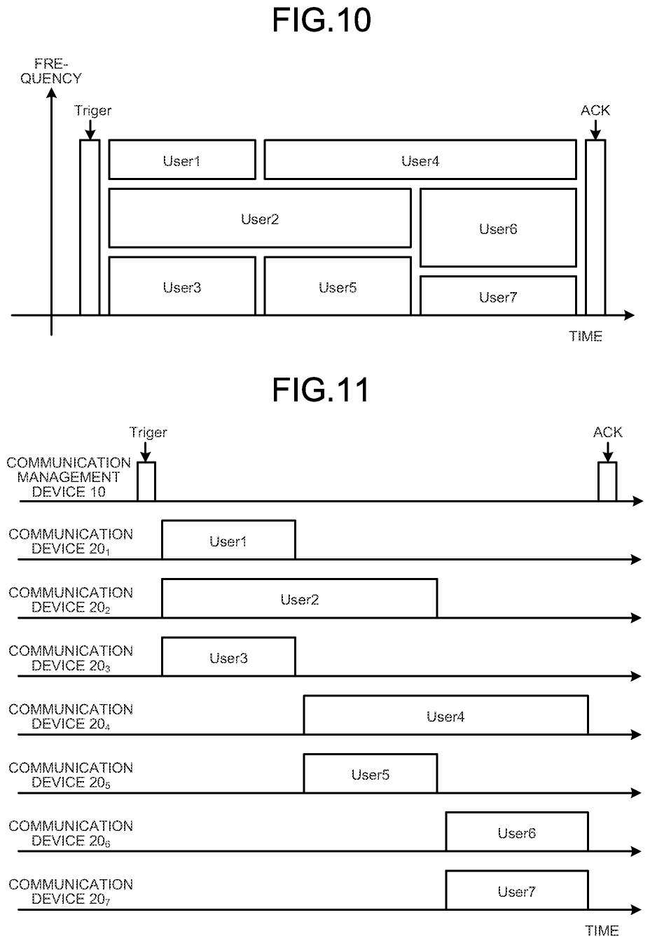

FIG. 10 is a diagram illustrating a usage status of a transmission line in a communication system that uses radio waves in units of frequency channel. Specifically, FIG. 10 is a diagram illustrating an example of multi-user multiplexing described in IEEE802.11ax. A wireless LAN system performs orthogonal frequency division multiple access (OFDMA). The wireless LAN system performs multiplexing in both the time division direction and the frequency axis direction, thereby achieving wireless transmission with higher efficiency. In the example of FIG. 10, a predetermined trigger (for example, a trigger frame) or common header information is followed by communication resources allocated to individual communication devices (users) in units of resource unit. The communication management device 10 may transmit a trigger frame by using the frequency bandwidth of 20 MHz so that all the communication devices 20 can grasp the trigger frame. Furthermore, the communication management device 10 may return a receipt acknowledgment (ACK illustrated in FIG. 10) after the multi-user multiplex communication is performed. With this configuration, each of the communication devices 20 can determine whether the data has been correctly received by the communication management device 10.

FIG. 11 is a diagram illustrating an execution example of uplink multi-user multiplexing. Specifically, FIG. 11 illustrates an example in which the communication management device 10 and the communication devices 20₁ to 20₇ communicate using resource units. In the example of FIG. 11, the communication management device 10 first transmits a trigger frame. Subsequently, the communication devices 20 (communication devices 20₁ to 20₇) that have received the trigger frame are configured to transmit user data accordingly. The resource units allocated to each of pieces of user data would not conflict with each other. Therefore, the communication management device 10 can receive the data transmitted from the individual communication devices 20 together. The communication management device 10 can determine whether to receive the data sent from each of the communication devices 20 by decoding data in accordance with the configuration of the resource unit described in the trigger frame. Subsequently, the communication management device 10 returns an ACK frame to the communication device for which receipt has been acknowledged.

### 4. Resource Unit Allocation Example

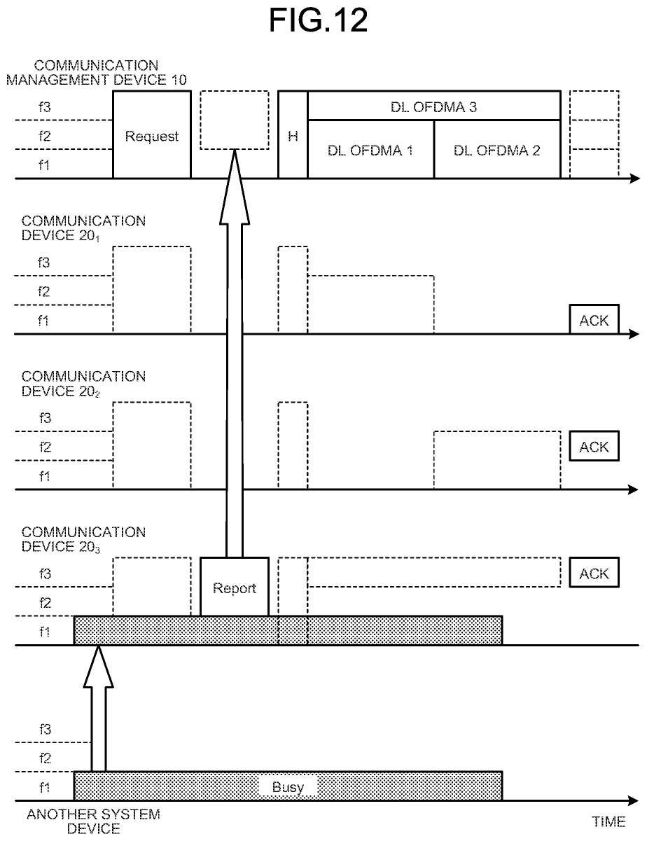

Next, an example of resource unit allocation will be described with reference to FIGS. 12 to 19. In the example of FIG. 8, one frequency channel (20 MHz) is divided into nine resource units in the frequency axis direction. However, in the examples of FIGS. 12 to 19, one frequency channel is divided into three (f1 to f3) for the sake of clarity.

<4-1. Downlink Allocation Example>

First, an example of reporting operation in the downlink will be described. FIG. 12 is a diagram illustrating an example of resource unit allocation in downlink multi-user multiplex communication. First, the communication management device 10 transmits a frame requesting a report (hereinafter, also referred to as a report request frame) using all the narrow-bands included in the frequency channel (that is, all the resource units in the frequency direction). The report request frame is a request for transmitting the interference signal detection result. The communication management device 10 may transmit an independent report request frame for each of narrow-bands.

The communication device 20 returns a report in response to the report request frame. The report contains interference signal detection information. In the example of FIG. 12, the communication device 20₁ and the communication device 20₂ have not received an interference signal from another system device, and thus can receive the report request frame without any problem. However, the communication device 20₃ has received an interference signal from another system device, and thus, cannot completely receive the report request frame. For example, after determining which part of the report request frame is missing, the communication device 20₃ can detect which narrow-band involves the interference signal. In the example of FIG. 12, the communication device 20₃ has interference in narrow-band f1. The communication device 20 having the interference from another system device transmits information related to the narrow-band (or resource unit) involving interference to the communication management device 10 as detection information. In the example of FIG. 12, the communication device 20₃ transmits, to the communication management device 10, a report including information indicating detection of the interference signal in the narrow-band f1 (for example, detection information indicating that the resource unit in the narrow-band f1 is not available).

Note that the communication device 20 may return a report using a resource unit excluding the subcarrier involving the interference. Furthermore, each of the communication devices 20 may return a report by randomly using a resource unit that is not affected by the interference signal. That is, in a case where the communication device 20 has received the report request frame from the communication management device 10 in two or more narrow-bands, the communication device 20 may transmit the report using the narrow-band in which no interference signal has been detected among the two or more narrow-bands.

The communication management device 10 receives the communication device 20₃ and specifies the narrow-band (or resource unit) in which the communication device 20₃ has detected the interference signal. With this configuration, the communication management device 10 can grasp the resource unit belonging to the narrow-band in which the communication device 20₃ has detected the interference signal from another system device (in the example of FIG. 12, the resource unit belonging to narrow-band f1). The resource unit belonging to a narrow-band in which an interference signal has been detected is referred to as a “resource unit in which an interference signal has been detected” in some cases.

Subsequently, in execution of the downlink multi-user multiplex communication, the communication management device 10 will not assign the corresponding resource unit (resource unit belonging to narrow-band f1) to the communication addressed to the communication device 20₃. In the example of FIG. 12, the communication management device 10 avoids using the resource unit belonging to narrow-band f1 and transmits data by using the resource unit belonging to narrow-band f3 in the communication addressed to the communication device 20₃. The communication management device 10 may use the resource unit in which the interference signal has been detected, for the communication with the other communication devices 20 (communication devices 20₁ and 20₂). In the example of FIG. 12, the communication management device 10 allocates resource units belonging to narrow-bands f1 and f2 including narrow-band f1 in which the communication device 20₃ has detected an interference signal, in the communication with the communication devices 20₁ and 20₂.

In the downlink multi-user multiplex communication, allocation information indicating which resource unit has been allocated to the communication device 20 is described in a header portion of the communication. Subsequently, each of the communication devices 20 can specify the resource unit addressed to oneself from the header information and can extract the data addressed to oneself. In a case where the data has been correctly received, each of the communication devices 20 may return ACK information to the access point.

In the example of FIG. 12, the report frame is returned immediately after transmission of the report request frame. However, in a case where it is necessary to grasp the frequency usage status of the transmission line in real time, using a quick feedback method would be effective.

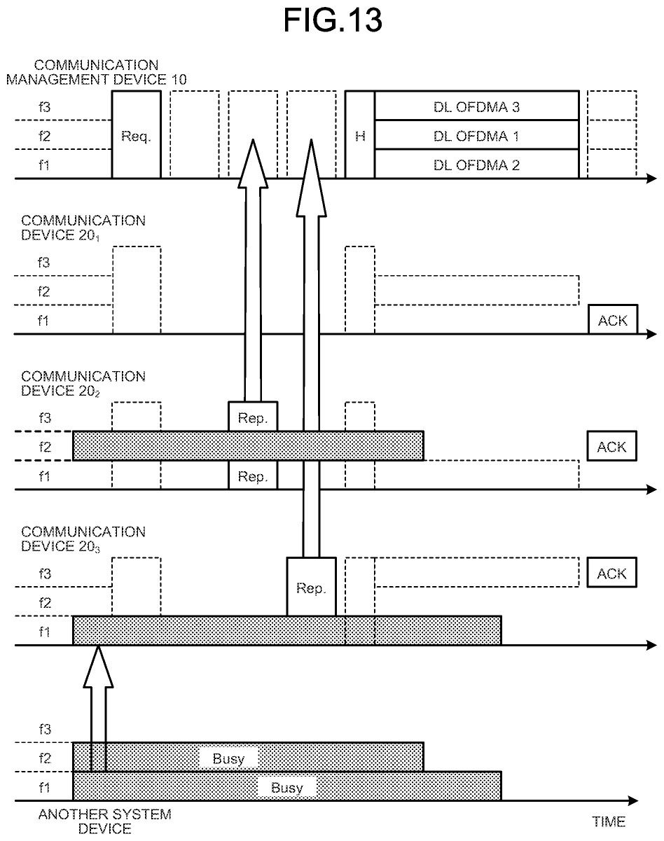

FIG. 13 is a diagram illustrating a modification of resource unit allocation in downlink multi-user multiplex communication. Similarly to the case of FIG. 12, FIG. 13 also illustrates an example in which the communication management device 10 transmits a report request frame using all the narrow-bands included in the frequency channel. In addition, in the example of FIG. 13, the communication device 20 returns the reports at shifted timings so that the communication management device 10 can receive the reports from the plurality of communication devices 20. That is, by designating the timing at which each of communication devices returns a report in the report request frame, the communication management device 10 can easily specify which communication device 20 receives the interference signal in which narrow-band.

Having not received any interference signal from another system device, the communication device 10₁ can receive a report request frame without any problem. Therefore, the communication device 10₁ will not transmit the report. However, since the communication devices 10₂ and 10₃ have interference from another system, these devices each return a report. At this time, the communication device 10₂ has interference in narrow-band f2, and thus, transmits a report using the resource units of narrow-band f1 and narrow-band f3. Furthermore, the communication device 10₃ has interference in narrow-band f1, and thus, transmits the report using the resource units of narrow-band f2 and narrow-band f3.

In this manner, in the example of FIG. 13, when a plurality of communication devices 20 has interference, the communication management device 10 can receive a report from the plurality of communication devices 20. Based on these report statuses, the communication management device 10 sets a resource unit to be used for communication with each of the communication devices 20 so as to avoid the use of the narrow-band involving the interference in the communication with the communication device 20 that has detected the interference. For example, in the example of FIG. 13, the resource unit belonging to narrow-band f1 is set as a resource unit to be used for communication with the communication device 20₂. Furthermore, the resource unit belonging to narrow-band f2 is set as a resource unit used for communication with the communication device 20₁. Furthermore, the communication management device 10 sets the resource unit belonging to the narrow-band f3 as a resource unit to be used for communication toward the communication device 20₃. Subsequently, the communication management device 10 executes data transmission addressed to each of the communication devices 20.

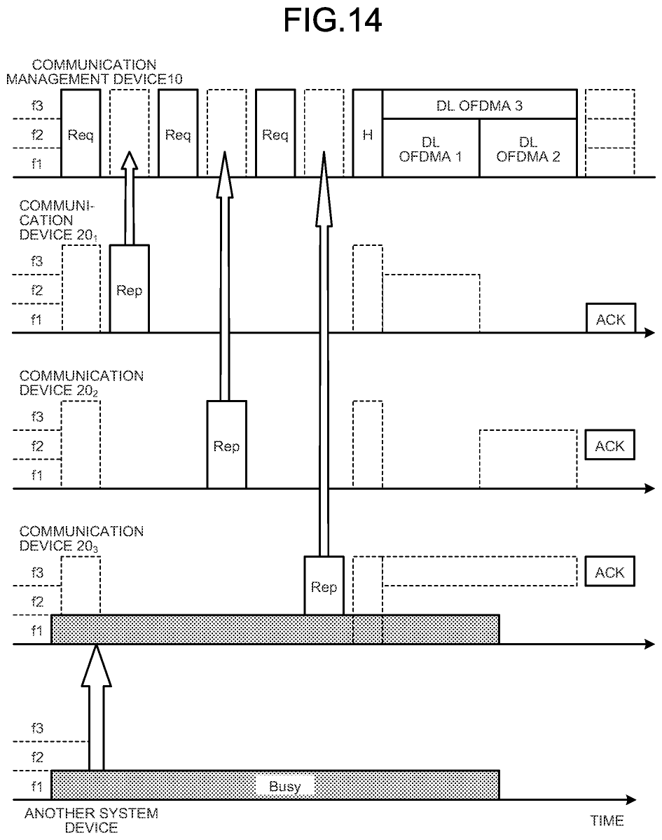

FIG. 14 is a diagram illustrating a modification of resource unit allocation in downlink multi-user multiplex communication. In the example of FIG. 14, the communication management device 10 unicasts a report request frame to a plurality of communication devices 20, and collects reports from each of the plurality of communication devices 20. That is, each of the communication devices 20 returns a report when it receives a report request frame addressed to itself even in a case where a device has no interference from other system devices. The communication management device 10 collects reports from all communication devices 20 and allocates a resource unit used for communication with each of the communication devices 20.

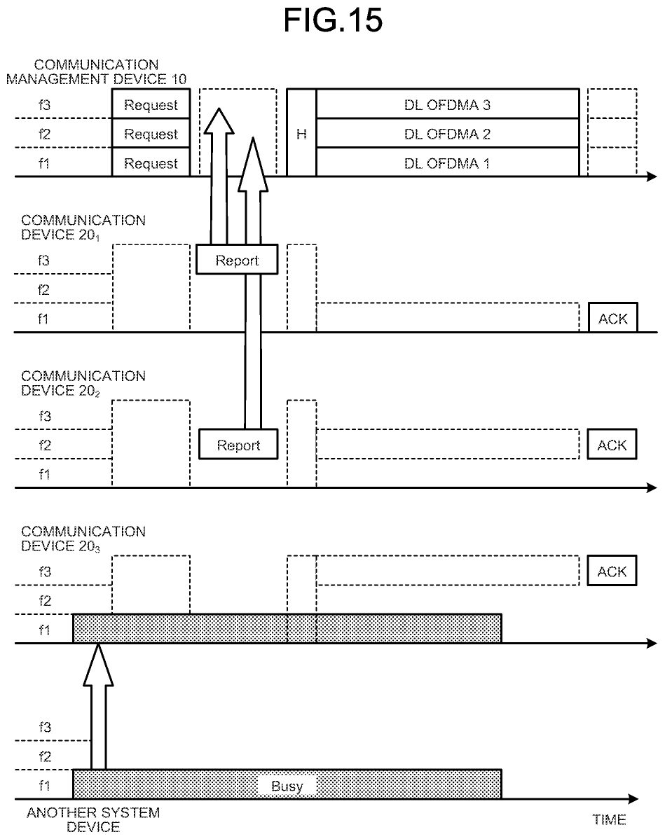

FIG. 15 is a diagram illustrating a modification of resource unit allocation in downlink multi-user multiplex communication. The communication management device 10 sets a specific narrow-band (resource unit) for each of the communication devices 20. For example, the communication management device 10 sets different narrow-bands for each of the plurality of communication devices 20. Subsequently, the communication management device 10 unicasts the report request frame using each of the set narrow-bands. Subsequently, the communication management device 10 determines the interference reception status of the communication device 20 in a set narrow-band based on the presence or absence of the reply to the report in the set narrow-band.

In the example of FIG. 15, even with no interference, each of the communication devices 20 is configured to return a report in the case of having received a report request frame addressed to itself. The communication management device 10 determines that the communication device 20 that has not returned to the report cannot communicate using the narrow-band set in the communication device 20. In the example of FIG. 15, the communication management device 10 allocates narrow-band f3 to the communication device 20₃. Since there is no report received from the communication device 20₃, the communication management device 10 can determine that the communication device 20₃ cannot communicate using narrow-band f1. Based on this determination result, the communication management device 10 determines to use a resource unit other than narrow-band f1 for communication with the communication device 20₃. In the example of FIG. 15, the communication management device 10 sets narrow-band f1 as a resource unit to be used for communication with the communication device 20₁. Furthermore, the communication management device 10 sets narrow-band f2 as a resource unit to be used for communication with the communication device 20₂. The communication management device 10 sets narrow-band f3 as a resource unit to be used for communication with the communication device 20₃. Subsequently, the communication management device 10 executes data transmission addressed to each of the communication devices 20.

<4-2. Uplink Allocation Example>

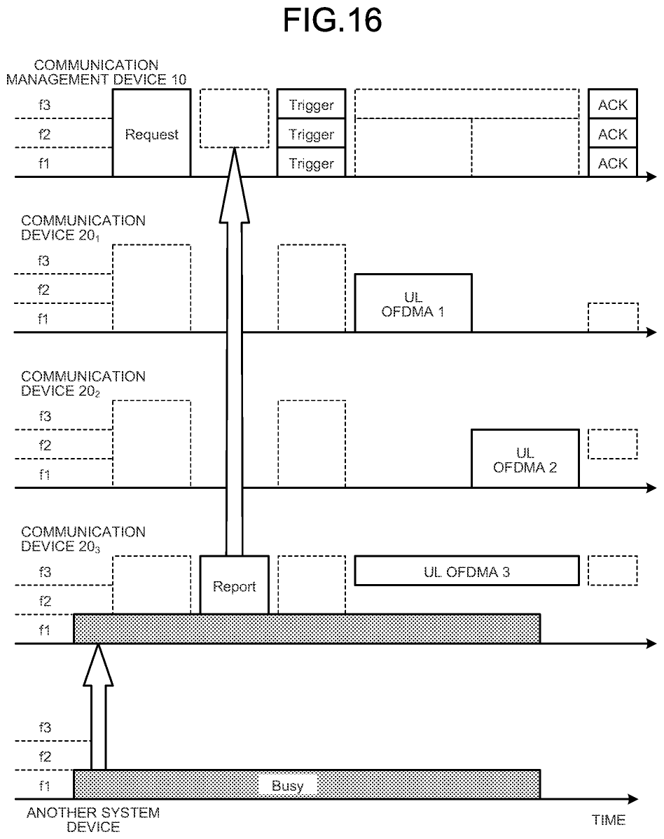

FIG. 16 is a diagram illustrating an example of resource unit allocation in uplink multi-user multiplex communication. In the example of FIG. 16, an uplink OFDMA communication sequence is displayed for each of frequency axes and each of the communication devices 20. The usage pattern of the frequency is the same as the above figure. Note that, in the uplink multi-user multiplex communication, information regarding the resource unit to be used by each of the communication devices 20 is described in the trigger frame. That is, in the case of the communication device 20 receiving interference from another system device, a narrow-band resource unit without interference is described in the trigger frame. For example, in the example of FIG. 16, narrow-band f1 has interference in the communication device 20₃. Therefore, a resource unit of narrow-band f3, which is a resource unit to be used by the communication device 20₃ for communication and which avoids a resource unit of narrow-band f1 having interference, is described in the trigger frame. Furthermore, resource units of narrow-bands f1 and f2 are described in the trigger frame as resource units to be used for communication by the other communication devices (communication devices 20₁ and 20₂).

Subsequently, each of the communication devices 20 specifies a resource unit that is to be used for own data transmission from the information described in the trigger frame. Subsequently, each of the communication devices 20 applies the transmission data to the specified resource unit and transmits the transmission data.

The communication management device 10 can acquire all the data by collecting all the data from each of the communication devices 20 transmitted in this manner. Subsequently, when correct data reception is successful, the communication management device 10 returns an ACK frame indicating receipt acknowledgment to each of the communication devices 20.

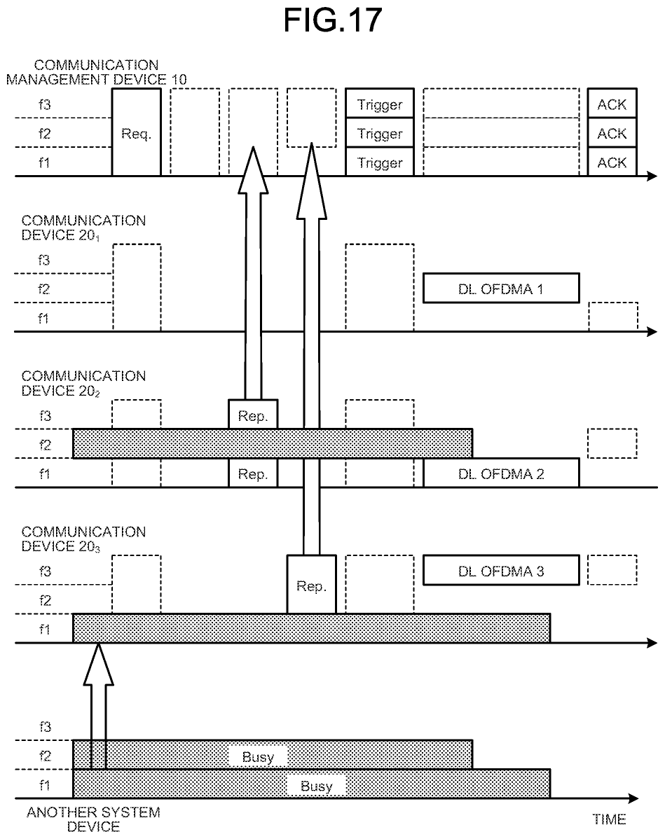

FIG. 17 is a diagram illustrating a modification of resource unit allocation in uplink multi-user multiplex communication. Similarly to the case of FIG. 16, FIG. 17 is also an example in which the communication management device 10 transmits a report request frame using all the narrow-bands included in the frequency channel. In addition, in the example of FIG. 17, the communication device 20 returns the reports at shifted timings so that the communication management device 10 can receive the reports from the plurality of communication devices 20. That is, by designating the timing at which each of communication devices returns a report in the report request frame, the communication management device 10 can easily specify which communication device 20 receives the interference signal in which narrow-band.

Having not received any interference signal from another system device, the communication device 10₁ will not transmit a report. However, since the communication devices 10₂ and 10₃ have interference from another system, these devices each return a report. At this time, the communication device 10₂ has interference in narrow-band f2, and thus, transmits the report using the resource units of narrow-band f1 and narrow-band f3. Furthermore, the communication device 10₃ has interference in narrow-band f1, and thus, transmits the report using the resource units of narrow-band f2 and narrow-band f3.

In this manner, in the example of FIG. 17, when a plurality of communication devices 20 has interference, the communication management device 10 can receive a report from the plurality of communication devices 20. Based on these report statuses, the communication management device 10 sets a resource unit to be used for communication with each of the communication devices 20 so as to avoid the use of the narrow-band involving the interference in the communication with the communication device 20 that has detected the interference. For example, in the example of FIG. 17, the resource unit belonging to narrow-band f1 is set as a resource unit to be used for communication with the communication device 20₂. Furthermore, the resource unit belonging to narrow-band f2 is set as a resource unit used for communication with the communication device 20₁. Furthermore, the communication management device 10 sets the resource unit belonging to the narrow-band f3 as a resource unit to be used for communication with the communication device 20₃. Subsequently, the communication management device 10 transmits a trigger frame containing the setting to each of the communication devices 20.

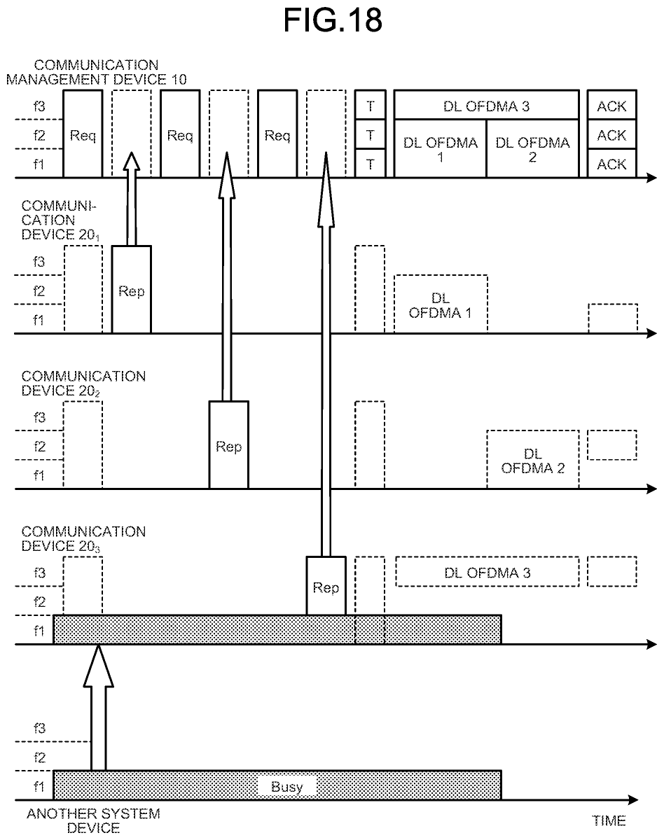

FIG. 18 is a diagram illustrating a modification of resource unit allocation in uplink multi-user multiplex communication. In the example of FIG. 18, the communication management device 10 unicasts a report request frame to the plurality of communication devices 20, and collects reports from each of the plurality of communication devices 20. That is, each of the communication devices 20 returns a report when it receives a report request frame addressed to itself even in a case where a device has no interference from other system devices. The communication management device 10 collects reports from all communication devices 20 and sets a resource unit used for communication with each of the communication devices 20. Subsequently, the communication management device 10 transmits a trigger frame containing the setting to each of the communication devices 20.

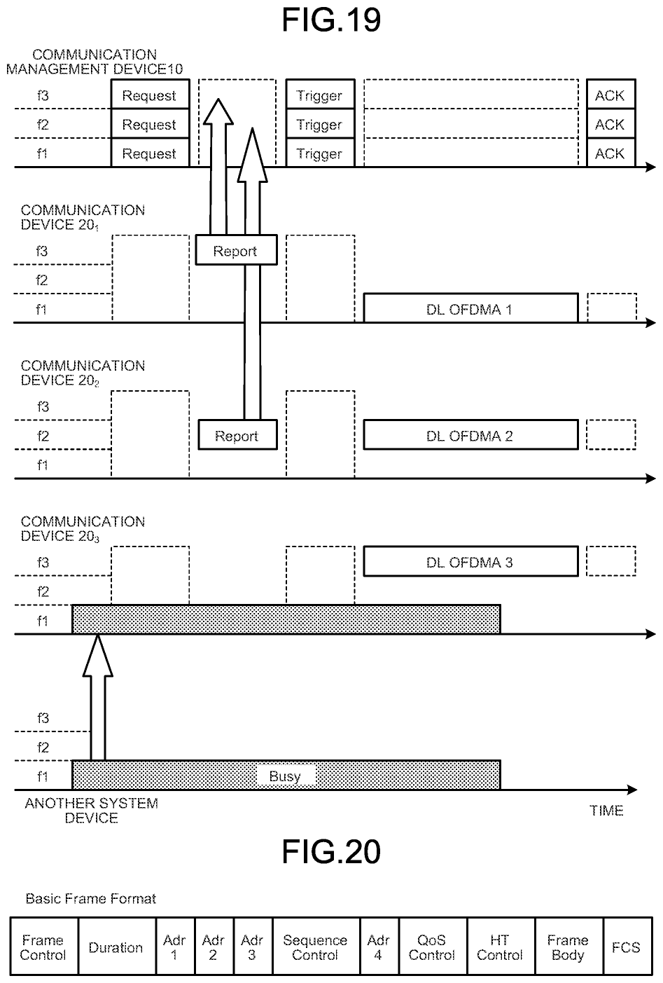

FIG. 19 is a diagram illustrating a modification of resource unit allocation in uplink multi-user multiplex communication. The communication management device 10 sets a specific narrow-band (resource unit) for each of the communication devices 20. For example, the communication management device 10 sets different narrow-bands for each of the plurality of communication devices 20. Subsequently, the communication management device 10 unicasts the report request frame using each of the set narrow-bands. Subsequently, the communication management device 10 determines the interference reception status of the communication device 20 in a set narrow-band based on the presence or absence of the reply to the report in the set narrow-band.

In the example of FIG. 19, each of the communication devices 20 is configured to return a report in the case of having received a report request frame addressed to itself even with no interference. The communication management device 10 determines that the communication device 20 that has not returned to the report cannot communicate using the narrow-band set in the communication device 20. In the example of FIG. 19, the communication management device 10 allocates narrow-band f3 to the communication device 20₃. Since there is no report received from the communication device 20₃, the communication management device 10 can determine that the communication device 20₃ cannot communicate using narrow-band f1. Based on this determination result, the communication management device 10 determines to use a resource unit other than narrow-band f1 for communication with the communication device 20₃. In the example of FIG. 19, the communication management device 10 sets narrow-band f1 as a resource unit to be used for communication with the communication device 20₁. Furthermore, the communication management device 10 sets narrow-band f2 as a resource unit to be used for communication with the communication device 20₂. The communication management device 10 sets narrow-band f3 as a resource unit to be used for communication with the communication device 20₃. Subsequently, the communication management device 10 transmits a trigger frame containing the setting to each of the communication devices 20.

### 5. Frame Configuration

Next, configurations of frames used by the communication management device 10 and the communication device 20 for communication will be described with reference to FIGS. 20 to 28. The following frame configurations are frame configurations for wireless LAN systems. However, the frame configuration can also be applied to communication systems other than wireless LAN systems.

<5-1. Basic Frame>

FIG. 20 is a diagram illustrating a configuration example of a basic frame. The basic frame is a frame uses as a base. A basic frame includes a MAC header, a frame body, and a frame check sequence (FCS).

The MAC header contains Frame Control, which indicates the format of the frame, Duration, which indicates the duration of the frame, and address fields (Address 1 to Address 4) that identify the recipient communication device and the source communication device. In addition, the MAC header includes Sequence Control including a sequence number, QoS Control in which Qos parameters are described, and HT Control in which high-throughput control information is described.

In a basic frame, the frame body portion contains required information elements. At the end, a frame check sequence for error detection is attached.

<5-2. Request Frame>

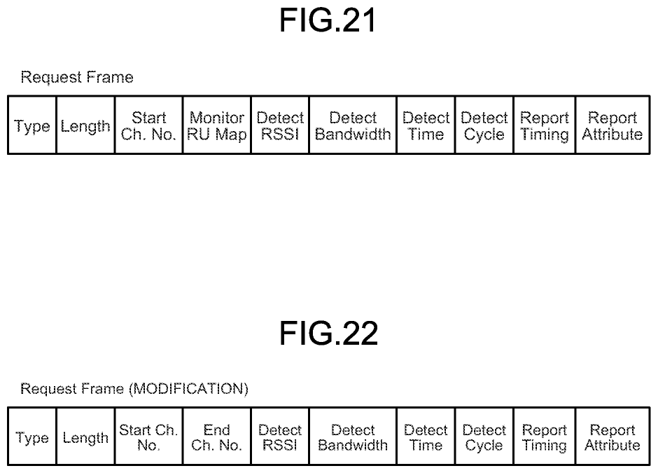

FIG. 21 is a diagram illustrating information elements described in a request frame of a report. The request frame of a report (report request frame) is a request for transmitting an interference signal detection result from the communication management device 10 to the communication device 20. The report request frame contains information regarding the range of resource units. The communication device 20 returns a report when it has detected a narrow-band signal (interference signal) that covers at least this range.

The report request frame contains information element type (Type), information length (Length), start channel number (Start Channel No.), and bitmap information regarding the resource unit to be monitored (Monitor RU Map). The report request frame further contains a received signal strength to be detected (Detect RSSI), a bandwidth to be detected (Detect Bandwidth), a temporal resolution to be detected (Detect Time), and a time cycle to be detected (Detect Cycle). In addition, the report request frame contains a timing of reporting (Report Timing) and a report method attribute (Report Attribute).

FIG. 22 is a diagram illustrating a modification of the information element described in the request frame of a report. This frame also contains information regarding the range of resource units. The communication device 20 returns a report when it has detected a narrow-band signal (interference signal) that covers at least this range.

The report request frame according to the modification includes information element type (Type), information length (Length), start channel information (Start Channel No.), and end channel information (End Channel No.). The report request frame further contains a received signal strength to be detected (Detect RSSI), a bandwidth to be detected (Detect Bandwidth), a temporal resolution to be detected (Detect Time), and a time cycle to be detected (Detect Cycle). In addition, the report request frame contains a timing of reporting (Report Timing) and a report method attribute (Report Attribute).

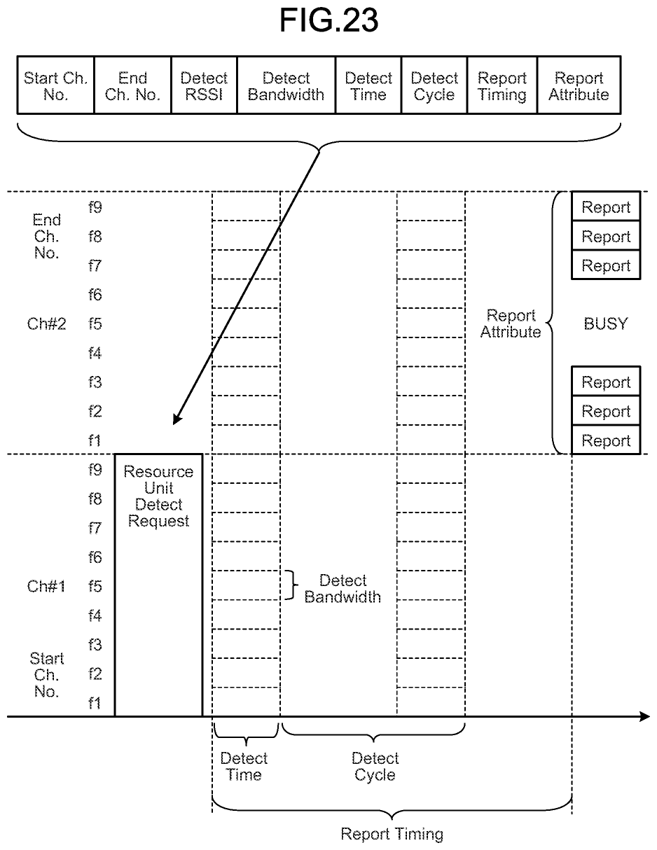

FIG. 23 is a diagram illustrating individual parameters included in the request frame of a report. The following will describe information represented by individual parameters: start channel information (Start Channel No.), end channel information (End Channel No.), received signal strength to be detected (Detect RSSI), bandwidth to be detected (Detect Bandwidth), temporal resolution to be detected (Detect Time), time cycle to be detected (Detect Cycle), the timing to report (Report Timing), and the attribute of the reporting method (Report Attribute).

First, the starting channel is set as a first channel (Ch #1) for convenience. The end channel is set as a second channel (Ch #2). Nine resource units are assigned to each of the channels.

The bandwidth to detect (Detect Bandwidth) is information that designates the bandwidth of the resource unit to be detected. In the present embodiment, the communication device 20 performs detection using the bandwidth of one resource unit as the resolution. In other words, the usage status (interference signal) is detected for 18 resource units from f1 of Ch #1 to f9 of Ch #2.

The detection temporal resolution (Detect Time) indicates the time until a signal is detected at that frequency component. In addition, the time cycle to be detected (Detect Cycle) is used to determine whether the detected signal is sustained.

The timing of reporting (Report Timing) describes how often the reporting should be performed after receiving the request frame. In the example of FIG. 23, the communication device 20 performs reporting every 2 Detect Cycles.

The reporting method attribute (Report Attribute) is attribute information indicating whether to report the current detection status only once, immediately after detection, or periodically.

In addition to this, the report request frame may contain the timing to return the report when a resource unit in use (BUSY) is detected within a predetermined channel range, and the position of the channel or resource at which the report is returned.

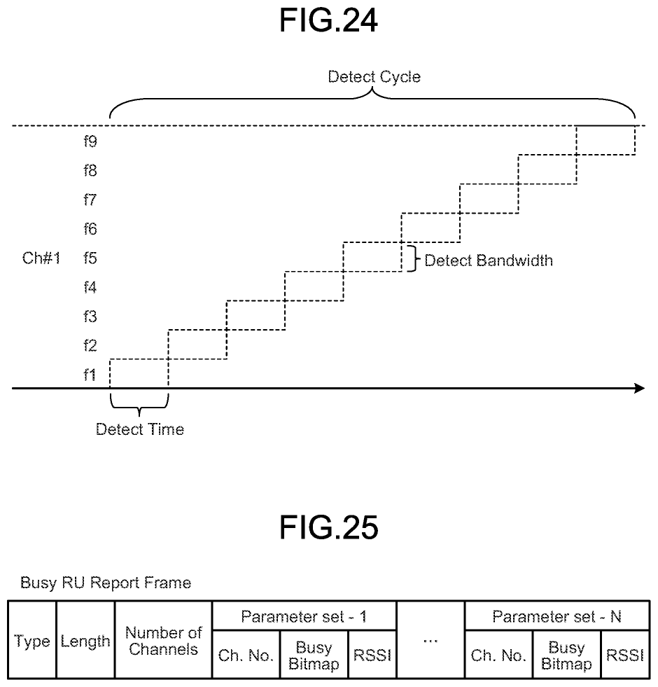

FIG. 24 is a diagram illustrating an example of an interference signal detection method. As illustrated in FIG. 24, in a case where the Detect Cycle is long, the communication device 20 attempts detecting the interference signal while sequentially switching narrow-band (resource unit) frequencies (f1 to f9) for one narrow-bands (one resource unit) and for each of the Detect Times.

<5-3. Busy RU Report Frame>

FIG. 25 is a diagram illustrating a configuration example of an information element described in a report frame. A report frame is transmitted from the communication device 20 to the communication management device 10. The report frame contains information regarding a narrow-band signal (interference signal) detected by the communication device 20. Specifically, the report frame contains information indicating a narrow-band (resource unit) in which the detected narrow-band signal exists. Based on the report frame, the communication management device 10 can grasp that a narrow-band signal exists in the neighborhood of the communication device that has sent the report frame.

Subsequently, in execution of multi-user multiplex communication by OFDMA, the communication management device 10 avoids allocation of at least a narrow-band resource unit in which this narrow-band signal exists to the communication device 20 that has transmitted the report frame.

The report frame contains the type of information element (Type), information length (Length), the number of channels to be reported (Number of Channels), and the parameter set corresponding to that number. The parameter set includes the channel number (Channel No.), the bitmap information (Busy Bitmap) of the resource unit in which the detected narrow-band signal exists, and the received signal strength (RSSI).

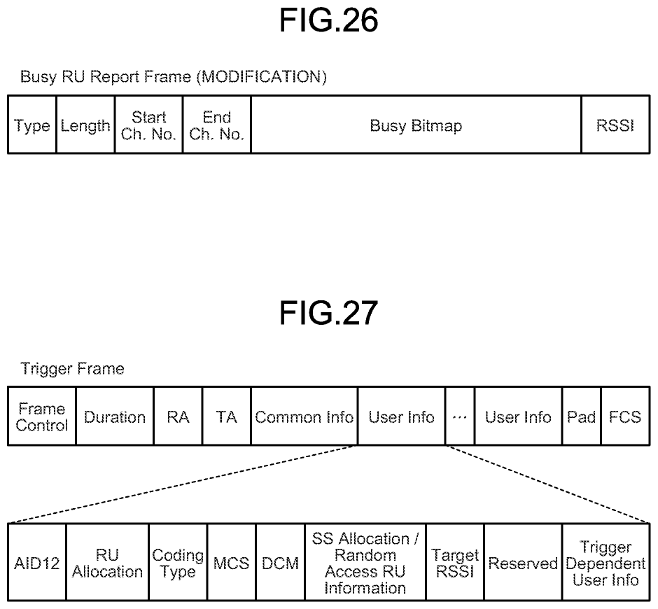

FIG. 26 is a diagram illustrating a modification of an information element described in a report frame. This frame is also transmitted from the communication device 20 to the communication management device 10. The report frame according to the modification contains information regarding a narrow-band signal (interference signal) detected by the communication device 20. Specifically, the report frame contains information indicating a narrow-band (resource unit) in which the detected narrow-band signal exists. Based on the report frame, the communication management device 10 can grasp that a narrow-band signal exists in the neighborhood of the communication device that has sent the report frame.

Subsequently, in execution of multi-user multiplex communication by OFDMA, the communication management device 10 avoids allocation of at least a narrow-band resource unit in which this narrow-band signal exists to the communication device 20 that has transmitted the report frame.

The report frame contains the type of information element (Type), information length (Length), start channel information (Start Channel No.), end channel information (End Channel No.), bitmap information (Busy Bitmap) of a resource unit in which a narrow-band signal corresponding to the channel width exists, and received signal strength (RSSI).

<5-4. Trigger Frame>

FIG. 27 is a diagram illustrating a configuration example of a trigger frame. The configuration of a trigger frame conforms to the configuration of the basic frame illustrated in FIG. 20. Although the MAC header is simplified, a frame check sequence (FCS) is added at the end. The trigger frame is broadcast to all the communication devices 20.

The report frame contains identification information (Frame Control), frame duration (Duration), recipient address (RA), and transmission source address (TA). In the case of a report frame, the identification information (Frame Control) stores information indicating that the frame is a trigger frame. The broadcast address is described in the recipient address (RA). The transmission source address (TA) has a description of the address of the communication device 20 that is the destination of the trigger frame.

The report frame further contains common information (Common Info) common to all communication devices 20 and user information (User Info) which is information addressed to individual users. The pieces of user information are set by the number corresponding to the number of multiplex configurations for multi-user communication. Padding (Pad) is added to this frame to reach a predetermined information length, and a frame check sequence (FCS) is further added, so as to form a trigger frame.

In addition, individual user information (User Info) includes abbreviated address identifier (AID12), resource allocation for OFDMA (RU Allocation), coding format (Coding Type), modulation method and coding rate (modulation and coding scheme: MCS), dual carrier modulation (DCM), resource unit Information for Random Access (Random Access RU Information), Target Received signal Strength (Target RSSI), and trigger-based user information (Trigger Dependent User Info).

In addition to this, any information may be described as appropriate, when information is necessary.

<5-5. DL OFDMA Header>

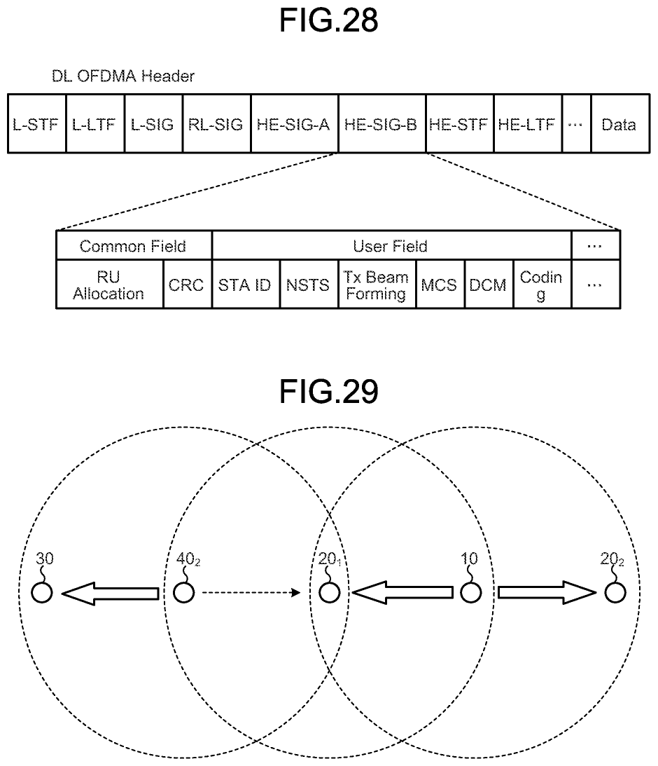

FIG. 28 is a diagram illustrating a configuration example of a downlink OFDMA header. The downlink OFDMA header is a header of a data frame in which downlink OFDMA multi-user multiplexing is performed. In this header, a predetermined preamble signal is configured as a physical layer convergence protocol (PLCP) header. The downlink OFDMA header contains a predetermined conventional training signal (L-STF, L-LTF), conventional signaling information (L-SIG), its repetition (LR-SIG), high-density communication signaling A (HE-SIG-A), high-density communication signaling B (HE-SIG-B), and high-density training signals (HE-STF and HE-LTF). The data defined in the basic frame configuration example illustrated in FIG. 20 is added to this header.

In the present embodiment, the high-density communication signaling B (HE-SIG-B) includes a common field (Common Field) and a user field for each of the users (User Field). The common field includes a resource allocation (RU Allocation) for OFDMA of the present embodiment and an error detection code (CRC). In addition, the user field also includes communication device identifier (STA ID), multiplex number (NSTS), transmit beamforming (Tx Beam Forming), modulation method and coding rate (MCS), and dual carrier modulation (DCM), and coding information (Coding).

### 6. Communication System Arrangement Mode

Next, an arrangement mode of a communication system and an operation example of the communication system in the arrangement mode will be described with reference to FIGS. 29 to 38.

<6-1. Arrangement Mode 1 (Downlink)>

FIG. 29 is a diagram illustrating an example of an arrangement mode of a communication system. Specifically, FIG. 29 is a diagram illustrating a relationship between the communication system 1 that implements downlink OFDMA and another system. In the example of FIG. 29, the other system is illustrated as a communication system 2. The communication system 2 includes a communication management device 30 and a communication device 40₂ that communicates with the communication management device 30. The communication system 1 includes: a communication device 20₁ located within a radio wave reception range of the communication device 40₂; and a communication device 20₂ located outside the radio wave reception range of the communication device 40₂. The communication system 1 including the communication device 20₁ and the communication device 20₂ is operated by the communication management device 10.

In the example of FIG. 29, it is assumed that neighboring communication devices are located at positions where mutual signals can be detected. The range of the dashed circle around each of the communication devices schematically illustrates that the signal can be detected. In the example of FIG. 29, the communication device 20₁ of the communication system 1 has detected a signal (interference signal) that is not intended to be received. The signal indicated by the dashed arrow in the figure is the interference signal. In the case of the example of FIG. 29, the interference signal is a signal transmitted by the communication management device 30 of the communication system 2 to the communication device 40₂.

With execution of processing of the present embodiment by the communication management device 10 and the communication device 20, the communication device 20₁ can receive the data transmitted from the communication management device 10 even when there is interference from another system. Open arrows in the figure indicate the downlink multi-user multiplexed data.

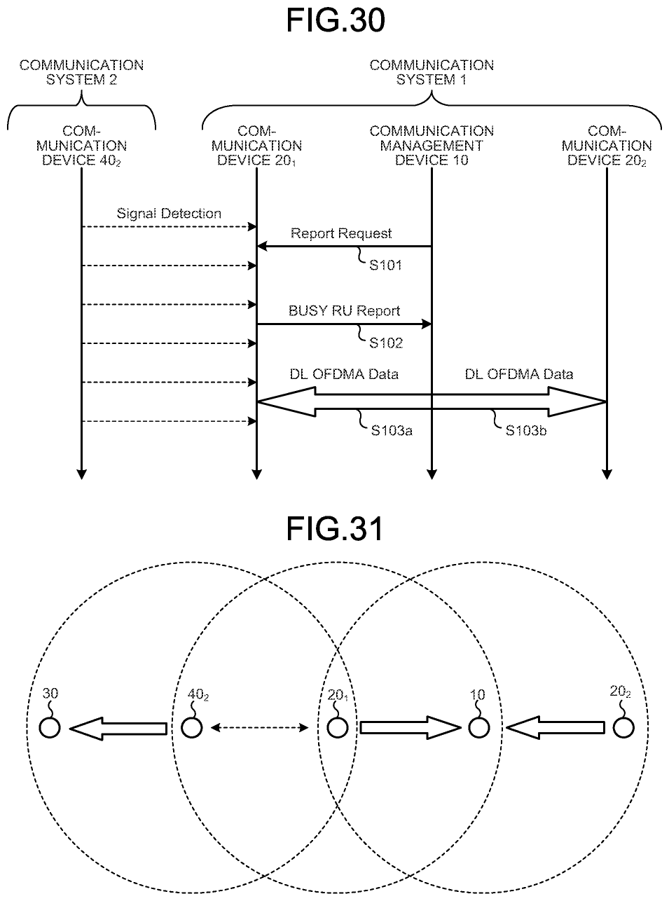

FIG. 30 is a sequence diagram illustrating an example of operation of the communication system 1 in the arrangement mode illustrated in FIG. 29. The example of FIG. 30 illustrates transmission of a report storing interference signal detection information (for example, the information of the resource unit in use) from the communication device 20₁ to the communication management device 10. In the example of FIG. 30, the communication management device 10 causes the communication device 20₁ to report whether a narrow-band signal (interference signal) has been detected immediately before the start of data transmission.

First, the communication management device 10 transmits a report request frame (Report Request) to the communication device 20₁ prior to the downlink multi-user multiplex data transmission (DL OFDMA) (step S101).

Having received the report request frame, the communication device 20₁ returns detection information indicating that a narrow-band signal from another system has been detected. Specifically, the communication device 20₁ transmits a report frame (BUSY RU Report) to the communication management device 10 (step S102).

Thereafter, the communication management device 10 allocates a resource unit (RU) involving no detection of a narrow-band signal to the communication device 20₁ that has transmitted this report frame. Subsequently, the communication management device 10 transmits the downlink multi-user multiplex data (DL OFDMA) (steps S103a and S103b).

With this process, the resource unit having no interference from other systems is used for communication with the communication device 20₁. Accordingly, the communication device 20₁ can receive the downlink multi-user multiplex data (DL OFDMA Data) addressed to itself without any problem.

<6-2. Arrangement Mode 2 (Uplink)>

FIG. 31 is a diagram illustrating an example of an arrangement mode of a communication system. Specifically, FIG. 31 is a diagram illustrating a relationship between the communication system 1 that implements uplink OFDMA and another system. In the example of FIG. 31, the other system is illustrated as a communication system 2. The communication system 2 includes a communication management device 30 and a communication device 40₂ that communicates with the communication management device 30. The communication system 1 includes: a communication device 20₁ located within a radio wave reception range of the communication device 40₂; and a communication device 20₂ located outside the radio wave reception range of the communication device 40₂. The communication system 1 including the communication device 20₁ and the communication device 20₂ is operated by the communication management device 10.

In the example of FIG. 31, it is assumed that neighboring communication devices are located at positions where mutual signals can be detected. The range of the dashed circle around each of the communication devices schematically illustrates that the signal can be detected. In the example of FIG. 31, the communication device 20₁ and the communication device 40₂ each have detected a signal (interference signal) that is not intended to be received. The signal indicated by the dashed arrow in the figure is the interference signal. In the example of FIG. 31, the interference signal for the communication device 20₁ is a signal transmitted by the communication management device 30 of the communication system 2 to the communication device 40₂. The interference signal for the communication device 40₂ is a signal transmitted by the communication device 40₂ of the communication system 1 to the communication management device 30.

With execution of processing of the present embodiment by the communication management device 10 and the communication device 20, the communication management device 10 can receive the data transmitted from the communication device 20₁ even when there is interference from another system. Open arrows in the figure indicate the uplink multi-user multiplexed data. The communication management device 10 can simultaneously communicate with a plurality of communication devices 20 (in the example of FIG. 31, the communication device 20₁ and the communication device 20₂).

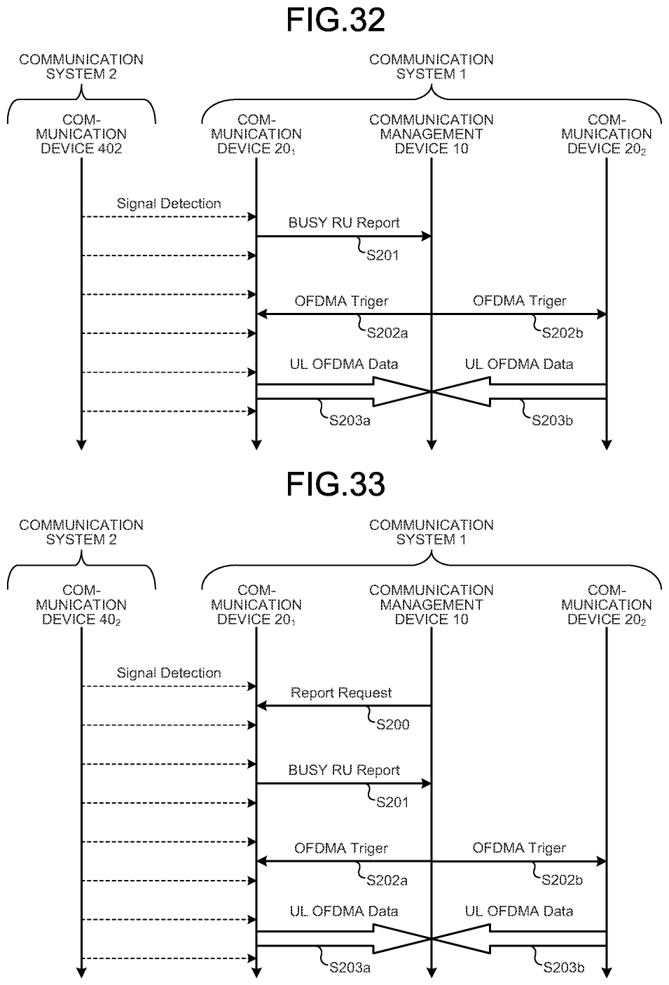

FIG. 32 is a sequence diagram illustrating an example of operation of the communication system in the arrangement mode illustrated in FIG. 31. The example of FIG. 32 illustrates transmission of a report storing interference signal detection information (for example, the information of the resource unit in use) from the communication device 20₁ to the communication management device 10. In the example of FIG. 32, the communication device 20₁ preliminarily reports the existence of a narrow-band signal (interference signal) to the communication management device 10.

Note that the communication management device 10 may transmit a report request frame (Report Request) to the communication device 20₁. At this time, the report request frame (Report Request) may be a frame that requests the communication device 20 to return a report as necessary when the device has detected a narrow-band signal (interference signal). Furthermore, the report request frame may be a frame that requests a report of detection of an interference signal immediately after the communication device 20 has detected the narrow-band signal (interference signal). Furthermore, the report request frame may be a frame that requests a report regarding an interference signal when a predetermined reporting timing has arrived. Alternatively, the report request frame may be a frame that requests a report regarding an interference signal at an arbitrary timing of the communication device 20.

The communication device 20₁ transmits the report in response to the request in the report request frame (step S201). For example, the communication device 20₁ transmits a report frame (BUSY RU Report) including interference signal detection information immediately after detecting the narrow-band signal (interference signal). The communication device 20₁ may transmit a report frame when a predetermined reporting timing arrives, or may transmit a report frame at any timing of the communication device 20₁, of course.

Having received the report frame, the communication management device 10 transmits a trigger frame to the communication device 20₁ and the communication device 20₂ (steps S202a and S202b). When transmitting the trigger frame, the communication management device 10 describes in the trigger frame that the resource unit having no narrow-band signal has been allocated to the communication device 20₁.

Subsequently, the communication device 20₁ and the communication device 20₂ transmit data to the communication management device 10 using the resource unit described in the trigger frame (steps S203a and S203b). This makes it possible to implement uplink multi-user multiplex data (UL OFDMA) avoiding interference with other systems.

FIG. 33 is a sequence diagram illustrating an example of operation of a communication system in the arrangement mode illustrated in FIG. 31. In the example of FIG. 33, the communication management device 10 causes the communication device 20₁ to report the presence/absence of detected narrow-band signal immediately before starting data transmission. That is, the communication management device 10 transmits a report request frame (Report Request) prior to the allocation of the resource unit for uplink multi-user multiplex data transmission (UL OFDMA) (step S200).

Having received the report frame, the communication management device 10 transmits a trigger frame to the communication device 20₁ and the communication device 20₂ (steps S202a and S202b). When transmitting the trigger frame, the communication management device 10 describes in the trigger frame that the resource unit having no narrow-band signal has been allocated to the communication device 20₁.

Subsequently, the communication device 20₁ and the communication device 20₂ transmit data to the communication management device 10 using the resource unit described in the trigger frame (steps S203a and S203b). This makes it possible to implement uplink multi-user multiplex data (UL OFDMA) avoiding interference with other systems.

<6-3. Arrangement Mode 3 (Uplink)>

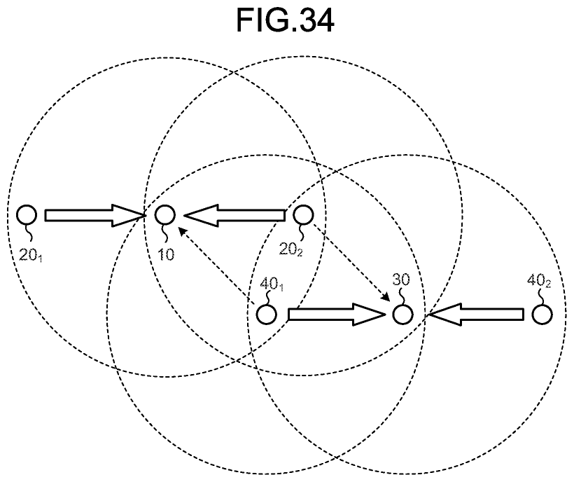

FIG. 34 is a diagram illustrating an example of an arrangement mode of a communication system. Specifically, FIG. 34 is a diagram illustrating a relationship between a plurality of communication systems that implement uplink OFDMA. In the example of FIG. 34, the communication systems are illustrated as a communication system 1 and a communication system 2. The communication system 1 includes a communication management device 10 and communication devices 20₁ and 20₂ that communicate with the communication management device 10. The communication system 2 includes a communication management device 30 and communication devices 40₁ and 40₂ that communicate with the communication management device 30.

The communication management device 10 is located outside the radio wave reception range of the communication management device 30 and within the radio wave reception range of the communication device 40₁. The communication management device 30 is located outside a radio wave reception range of the communication management device 10 and within the radio wave reception range of the communication device 20₂.

In this case, the signal from the communication device 40₁ becomes an interference signal (dashed arrow in the figure) for the communication management device 10. Furthermore, the signal from the communication device 20₂ can be an interference signal (dashed arrow) for the communication management device 30. That is, the communication management device 10 regards the signal from the communication device 40₁ a signal from the OBSS overlapping its own BSS while the communication management device 30 regards the signal from the communication device 20₂ a signal from the OBSS overlapping its own BSS.

In the example of FIG. 34, uplink OFDMA is implemented in both communication systems. Here, the communication management device 10 can detect the transmission signal (resource unit used for transmission) of the communication device 20₂ as an interference signal. The communication management device 30 can detect the transmission signal (resource unit used for transmission) of the communication device 40₁ as an interference signal.

In the example of FIG. 34, the two communication management devices cannot communicate directly with each other. However, with a configuration in which the two communication management devices individually detect signals from the OBSS communication devices and allocate resource units that would not affect each other, it is possible to achieve coexistence of uplink OFDMA data communication schemes.

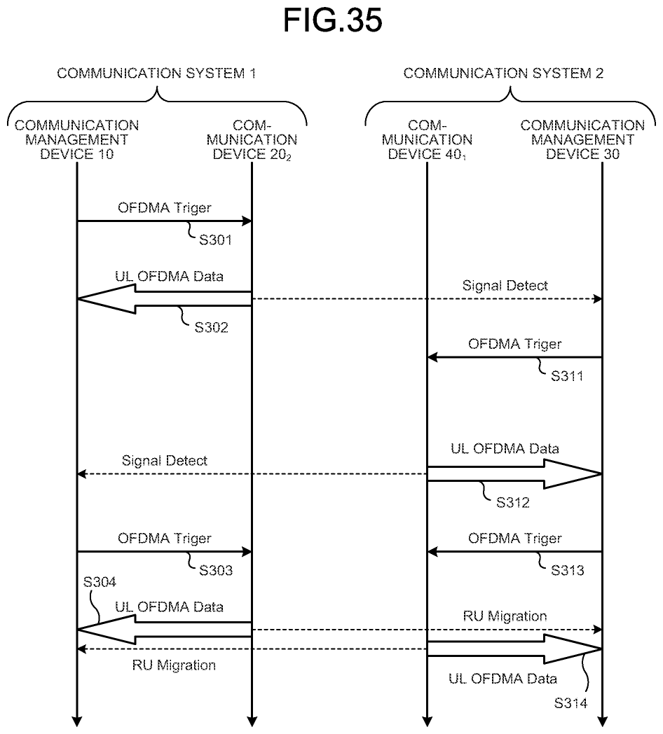

FIG. 35 is a sequence diagram illustrating an example of operation of a communication system in the arrangement mode illustrated in FIG. 34. In the example of FIG. 35, the communication management devices 10 and 30 individually use a trigger frame to allocate resource units to the communication devices under control. In the example of FIG. 35, each of the communication management devices determines the resource unit to be used in its own BSS based on the self detected interference signal (that is, the usage status of the resource unit in OBSS).

First, the communication management device 10 transmits a trigger frame (OFDMA Trigger) for uplink OFDMA (step S301). In response to this, the communication device 20₂ transmits data to the communication management device 10 (step S302).

Subsequently, the communication management device 30 detects the data transmitted by the communication device 20₂ as a narrow-band signal (interference signal) from the OBSS. In the subsequent communication, the communication management device 30 avoids using the resource unit belonging to the narrow-band in which the interference signal has been detected, for communication. That is, in the case of transmitting a trigger frame (OFDMA Trigger) (step S311), the communication management device 30 describes in the trigger frame an instruction to use a resource unit that has no interference. In response to this, the communication device 40₁ transmits data to the communication management device 30 using the resource unit in which no narrow-band signal is detected (step S312). Thereafter, the transmission of the trigger frame by the communication management device 30 (step S313) and the transmission of data by the communication device 40₁ (step S314) will be repeated.

After the communication device 40₁ transmits data (step S312), the communication management device 10 detects the data transmitted by the communication device 40₁ as a narrow-band signal (interference signal) from the OBSS. In the subsequent communication, the communication management device 10 avoids using the resource unit (RU) belonging to the narrow-band in which the interference signal has been detected, for communication. That is, in the case of transmitting a trigger frame (OFDMA Trigger) (step S303), the communication management device 10 describes in the trigger frame an instruction to use a resource unit that has no interference. In response to this, the communication device 20₂ transmits data to the communication management device 10 using the resource unit in which no narrow-band signal is detected (step S304).

This makes it possible for both the communication management devices to avoid overlapping of individual resource units to use in the uplink OFDMA.

<6-4. Arrangement Mode 4 (Uplink)>

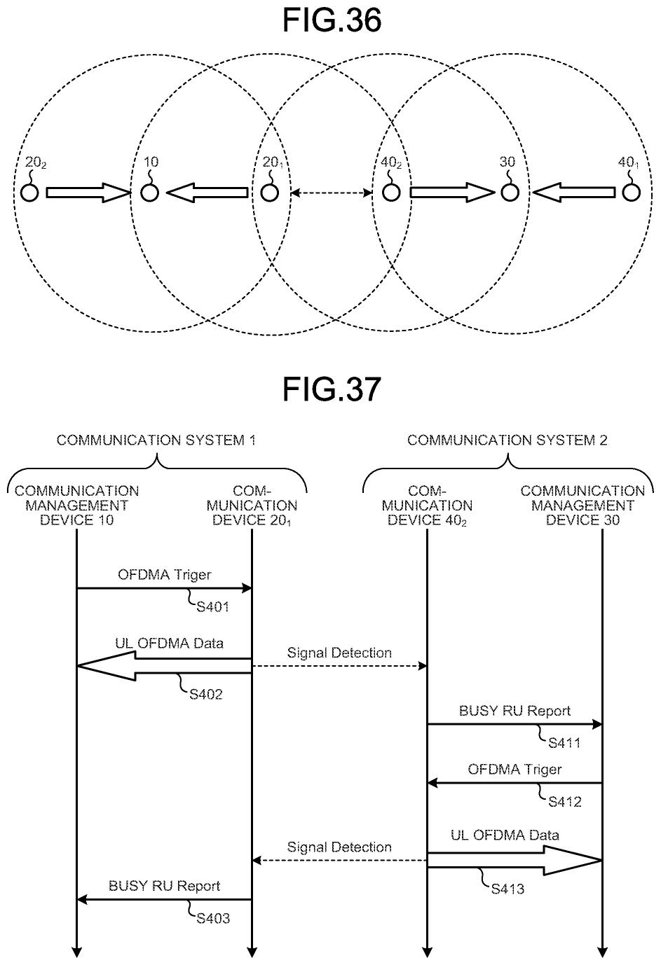

FIG. 36 is a diagram illustrating an example of an arrangement mode of a communication system. FIG. 36 is a diagram illustrating a relationship between a plurality of communication systems that implement uplink OFDMA. In the example of FIG. 36, the communication systems are illustrated as a communication system 1 and a communication system 2. The communication system 1 includes a communication management device 10 and communication devices 20₁ and 20₂ that communicate with the communication management device 10. The communication system 2 includes a communication management device 30 and communication devices 40₁ and 40₂ that communicate with the communication management device 30.

In the example of FIG. 36, uplink OFDMA is implemented in both communication systems. Specifically, communication from the communication devices 20₁ and 20₂ to the communication management device 10 and communication from the communication devices 40₁ and 40₂ to the communication management device 30 are implemented.

In the example of FIG. 36, neighboring radio communication devices are located at positions where they can detect mutual signals. Here, the radio communication devices are communication management devices 10 and 30, and communication devices 20 and 40. The dashed circle around the radio communication device indicates the detectable range (radio wave reception range) of the signal. In the example of FIG. 36, the communication device 20₁ and the communication device 40₂ are located at places where they detect mutual signals as interference signals (dashed arrows).

That is, the radio communication device included in the communication system 2 is recognized as OBSS by the radio communication device included in the communication system 1, while the radio communication device included in the communication system 1 is recognized as OBSS by the radio communication device included in the communication system 2.

FIG. 37 is a sequence diagram illustrating an example of operation of a communication system in the arrangement mode illustrated in FIG. 36. In the example of FIG. 37, the communication management devices 10 and 30 individually use a trigger frame to allocate resource units to the communication devices under control. In the example of FIG. 37, each of the communication management devices determines a source unit to be used in its own BSS based on interference signal information (that is, detection information) detected by the communication device under control. The example of FIG. 37 assumes that there is a preliminary setting in each of the communication devices that in a case where the communication device detects a narrow-band signal (interference signal), the communication device would transmit a report to the communication management device.

First, the communication management device 10 transmits a trigger frame (OFDMA Trigger) for uplink OFDMA (step S401). In response to this, the communication device 20₁ transmits data to the communication management device 10 (step S402).

Subsequently, the communication device 40₂ detects the data transmitted from the communication device 20₁ as an interference signal. Having detected the interference signal, the communication device 40₂ transmits a report (BUSY RU Report) to the communication management device 30 (step S411). In the subsequent communication, the communication management device 30 avoids using the resource unit belonging to the narrow-band in which the interference signal has been detected, for communication. That is, in the case of transmitting a trigger frame (OFDMA Trigger) (step S412), the communication management device 30 describes in the trigger frame an instruction to use a resource unit that has no interference. In response to this, the communication device 40₂ transmits data to the communication management device 30 using the resource unit in which no narrow-band signal is detected (step S413).

After the communication device 40₂ transmits data (step S413), the communication device 20₁ detects the data transmitted by the communication device 40₂ as an interference signal. After the communication device 20₁ detects the interference signal, the communication device 20₁ transmits a report (BUSY RU Report) to the communication management device 10 (step S403). In the subsequent communication, the communication management device 10 avoids using the resource unit (RU) belonging to the narrow-band in which the interference signal has been detected, for communication. That is, the communication management device 10 describes in the trigger frame an instruction to use the resource unit that has no interference. In response to this, the communication device 20₁ transmits data to the communication management device 10 using the resource unit in which no narrow-band signal is detected.

This makes it possible for both the communication management devices to avoid overlapping of individual resource units to use in the uplink OFDMA.

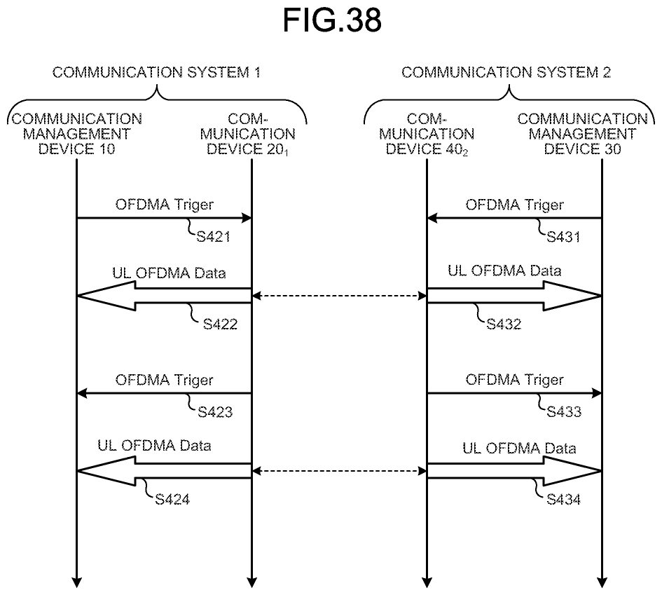

FIG. 38 is a sequence diagram illustrating an example of operation of a communication system in the arrangement mode illustrated in FIG. 36. FIG. 38 illustrates an example in which uplink OFDMA is performed in both neighboring networks. That is, FIG. 38 illustrates an example in which uplink OFDMA is implemented between neighboring BSSs while avoiding resource unit conflicts, as a result of a communication device report (BUSY RU Report).

First, the communication management device 10 transmits a trigger frame (OFDMA Trigger) for uplink OFDMA (step S421). The trigger frame contains information regarding resource units that avoid conflicts. With this description, a resource unit that avoids conflict with the neighboring communication device 40₂ will be allocate to the communication device 20₁. The communication device 20₁ uses the allocated resource unit to transmit data to the communication management device 10 (step S422). Similarly, the transmission of the trigger frame by the communication management device 10 (step S423) and the transmission of data by the communication device 20₁ (step S424) will be repeated.

Furthermore, the communication management device 30 transmits a trigger frame (OFDMA Trigger) for uplink OFDMA (step S431). The trigger frame contains information regarding resource units that avoid conflicts. With this description, a resource unit that avoids conflict with the neighboring communication device 20₁ will be allocate to the communication device 40₂. The communication device 40₂ uses the allocated resource unit to transmit data to the communication management device 10 (step S432). Similarly, the transmission of the trigger frame by the communication management device 30 (step S433) and the transmission of data by the communication device 40₂ (step S434) will be repeated.

Here, even in a case where the sessions of uplink OFDMA of the communication device 20₁ and the communication device 40₂ are implemented at the same timing or even in a case where the timings partially overlap each other, there would be no effect on mutual transmission. This makes it possible to achieve optimal use of resource units. Furthermore, by repeatedly allocating resource units that do not affect each other in a similar manner, it is possible to decrease the likelihood of occurrence of mutual interference between subsequent uplink OFDMA sessions.

### 7. Operation of Communication System

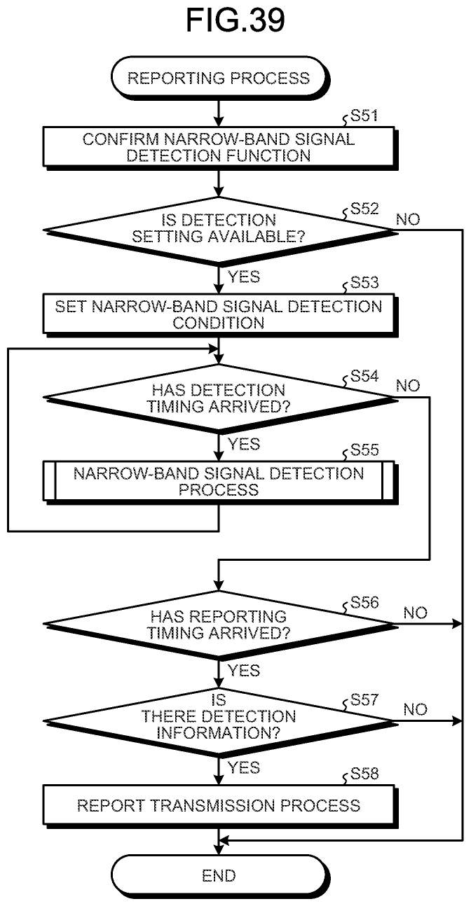

Next, operation of the communication system 1 will be specifically described with reference to FIGS. 39 to 48.

<7-1. Reporting Process>

First, a reporting process will be described. FIG. 39 is a flowchart illustrating an example of reporting process according to an embodiment of the present disclosure. The reporting process is a process of transmitting a report to the communication management device 10 when the communication device 20 detects a narrow-band signal. The reporting process is executed at a timing of reception of a report request frame, for example. Needless to say, the reporting process may be executed periodically. Hereinafter, the reporting process will be described with reference to the flowchart of FIG. 39.

First, the detection unit 252 of the communication device 20 confirms whether the signal detector (for example, the radio communication unit 21) of the communication device 20 is equipped with a narrow-band signal detection function (step S51). In a case where the detection function is not provided (step S52: No), the control unit 25 of the communication device 20 ends the reporting process. In a case where the detection function is provided (step S52: Yes), the detection unit 252 sets a narrow-band signal detection condition in the communication device 20 (step S53). At this time, the detection unit 252 may set the detection condition in accordance with the information described in the report request frame described with reference to FIGS. 21 to 24.

Subsequently, the detection unit 252 determines whether the detection timing of the narrow-band signal (interference signal) has arrived (step S54). The detection timing may be the timing described in the report request frame.

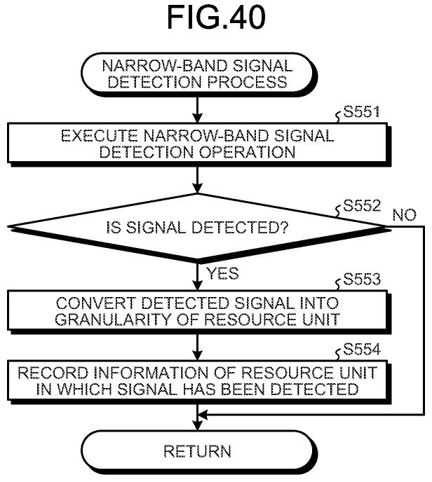

In a case where the detection timing has arrived (step S54: Yes), the detection unit 252 executes a narrow-band signal detection process (step S55). FIG. 40 is a flowchart illustrating an example of the narrow-band signal detection process according to an embodiment of the present disclosure. The narrow-band signal detection process is a process of detecting an interference signal with a narrow bandwidth as a unit of detection.

The detection unit 252 operates a narrow-band signal detecting portion (for example, the radio communication unit 21) (step S551) to grasp the presence of another system transmitting the signal (step S552). In a case where no signal is detected (step S552: No), the control unit 25 returns the process to the reporting process.

In a case where a signal is detected (step S552: Yes), the detection unit 252 converts the detected signal into the granularity of the resource unit (step S553). For example, the detection unit 252 determines the detection signal corresponds to which narrow-band among a plurality of predetermined narrow-bands (narrow-bands corresponding to resource units) located in the frequency direction. Subsequently, the detection unit 252 records the determined narrow-band in the storage unit 22 as a narrow-band (resource unit) in which the interference signal has been detected (step S554). Information related to the narrow-band (resource unit) in which the interference signal has been detected will be the interference signal detection information (detection result). The detection unit 252 may repeat the narrow-band signal detection process in step S55 until a detection result reporting timing arrives.

Returning to the flow of FIG. 39, in a case where the narrow-band signal (interference signal) detection timing has not arrived (step S54: No), the transmission unit 255 of the communication device 20 determines whether the detection result reporting timing for the narrow-band signal (interference signal) has arrived (step S56). The reporting timing may be the timing described in the report request frame. In a case where the reporting timing has not arrived (step S56: No), the control unit 25 ends the reporting process.

In a case where the reporting timing has arrived (step S56: Yes), the transmission unit 255 determines whether the interference signal detection information (detection result) is recorded in the storage unit 22 (step S57). In a case where there is no interference signal detection information (step S57: No), the control unit 25 ends the reporting process.

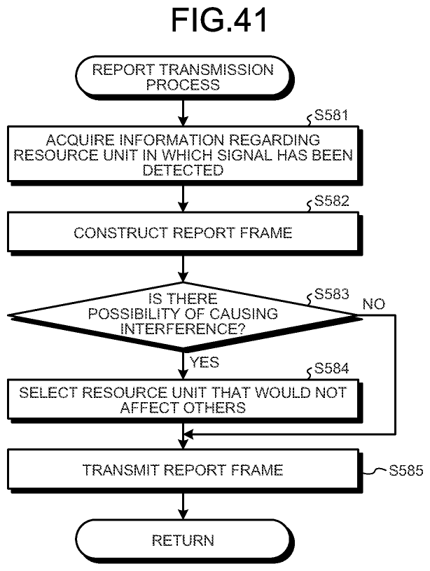

In a case where there is interference signal detection information (step S57: Yes), the transmission unit 255 executes a report transmission process (step S58). FIG. 41 is a flowchart illustrating an example of the report transmission process according to an embodiment of the present disclosure. The report transmission process is a process of transmitting a report frame including the interference signal detection result (detection information) to the communication management device 10.

The transmission unit 255 acquires, from the storage unit 22, information regarding the narrow-band (resource unit) in which the interference signal has been detected (step S581). Subsequently, the transmission unit 255 constructs a report frame indicating that the interference signal has been detected (step S582). The configuration of the report frame may be the configuration described with reference to FIGS. 25 to 26.

Subsequently, the transmission unit 255 determines whether there is a possibility of causing interference to another system by transmitting a report (step S583). In a case where there is no possibility of causing interference (step S583: No), the transmission unit 255 proceeds to step S585.

In a case where there is a possibility of causing interference (step S583: Yes), the transmission unit 255 selects a resource unit that would not affect other systems as a resource unit for report transmission (step S584). Subsequently, the transmission unit 255 transmits the report frame constructed in step S582 to the communication management device 10 (step S585). Note that, in a case where the reception unit 254 has received the report request frame from the communication management device 10 in two or more narrow-bands, the transmission unit 255 may transmit the report frame using the narrow-band in which no interference signal has been detected among the two or more narrow-bands.

After completion of the transmission, the control unit 25 returns to the reporting process flow of FIG. 39 and ends the reporting process.

In the reporting process illustrated in FIG. 39, the control unit 25 would not transmit a report in cases where there is no detection setting, there is no detection information, or where it is not the reporting timing. That is, in the reporting process illustrated in FIG. 39, the control unit 25 performs only the minimum necessary reporting. The reporting process is not limited to the process illustrated in FIG. 39. For example, the transmission unit 255 may be configured to transmit a report even when there is no detection setting, there is no detection information, or it is not the reporting timing.

<7-2. Reporting Receipt Process>

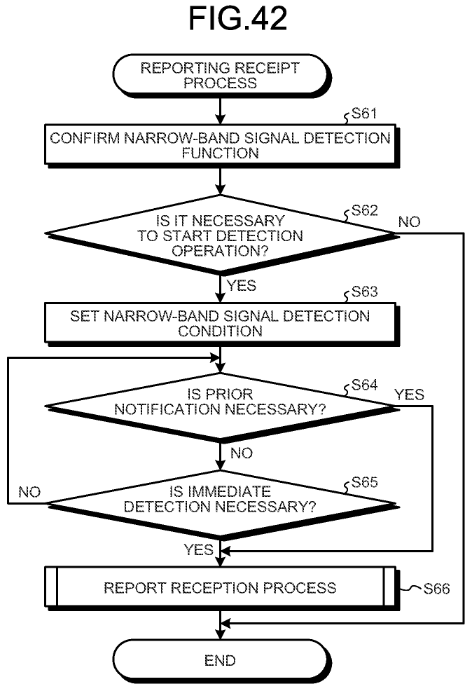

Next, the reporting receipt process will be described. FIG. 42 is a flowchart illustrating an example of reporting receipt process according to an embodiment of the present disclosure. The reporting receipt process is a process in which the communication management device 10 performs receipt of a report regarding an interference signal from the communication device 20. The reporting receipt process is periodically executed, for example. Hereinafter, the reporting receipt process will be described with reference to the flowchart of FIG. 42.

First, the acquisition unit 151 of the communication management device 10 confirms whether the communication device 20 has a narrow-band signal detection function (step S61). In a case where the narrow-band signal detection function is provided, the acquisition unit 151 determines whether it is necessary to start a narrow-band signal detection operation (step S62). For example, the acquisition unit 151 determines whether there is a possibility that another system exists in the surrounding area. In a case where it is not necessary to start the detection operation (step S62: No), the acquisition unit 151 proceeds to step S66 (or ends the process).

In a case where it is necessary to start the detection operation (step S62: Yes), the acquisition unit 151 sets a narrow-band signal detection condition (step S63). The detection condition set here is a condition used by the communication device 20 to detect a narrow-band signal, and is later stored in a report request frame so as to be transmitted to the communication device 20. At this time, the acquisition unit 151 may set the condition to be detected by each of the communication devices 20 or the timing to be reported, as the detection condition.

Next, the acquisition unit 151 determines whether it is necessary to notify the communication device 20 of the detection condition in advance (step S64). In a case where prior notification is necessary (step S64: Yes), the acquisition unit 151 proceeds to step S66. In a case where no prior notification is necessary (step S64: No), the acquisition unit 151 determines whether the narrow-band signal needs to be detected immediately (step S65). In a case where immediate detection is necessary (step S65: Yes), acquisition unit 151 proceeds to step S66. In a case where immediate detection is not necessary (step S65: No), acquisition unit 151 returns the process to step S64.

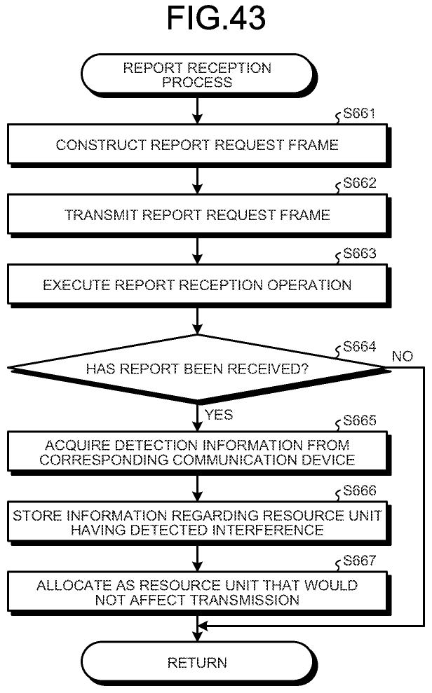

In a case where prior notification is necessary (step S64: Yes) or immediate detection is necessary (step S65: Yes), the acquisition unit 151 executes a report reception process (step S66). FIG. 43 is a flowchart illustrating an example of the report reception process according to an embodiment of the present disclosure. The report reception process is a process of receiving a report frame containing an interference signal detection result (detection information) from the communication device 20.

First, the construction unit 154 (or acquisition unit 151) of the communication management device 10 constructs a report request frame (step S661). The configuration of the report request frame may be the configuration described with reference to FIGS. 21 to 22. Subsequently, the transmission unit 155 (or acquisition unit 151) of the communication management device 10 transmits the report request frame constructed in step S661 to the communication device 20 (step S662). At this time, the transmission unit 155 may transmit the report request frame to the communication device 20 by using two or more narrow-bands among the plurality of narrow-bands included in the frequency channel, as described with reference to FIGS. 12 to 19. The communication device 20 is capable of receiving the report request frame even when there is interference from another system.

Subsequently, the acquisition unit 151 executes a reception operation for detecting the report frame from the communication device 20 (step S663). Subsequently, the acquisition unit 151 determines whether the report frame has been received from the communication device 20 (step S664). At this time, in a case where the transmission unit 155 has transmitted the report request frame using two or more narrow-bands, the acquisition unit 151 monitors the transmission of the report frame from the communication device 20 for the two or more narrow-bands. In a case where the report frame has not been detected (step S664: No), the control unit 25 of the communication management device 10 returns the process to the reporting receipt process.

In a case where the report frame is detected (step S664: Yes), the acquisition unit 151 acquires the detection information (information of the interference signal detected by the corresponding communication device 20) included in the report frame (step S665). Based on the detection information, the acquisition unit 151 specifies a narrow-band (or a resource unit belonging to the narrow-band) in which the interference signal has been detected. Subsequently, the acquisition unit 151 records the specified narrow-band (or resource unit) in the storage unit 12 (step S666). Subsequently, the acquisition unit 151 allocates the resource unit specified as a resource unit that would not affect data transmission (step S667).

After completion of the allocation, the control unit 15 returns to the flow of the reporting receipt process illustrated in FIG. 42 and ends the reporting receipt process.

<7-3. Communication Process (Communication Management Device Side)>

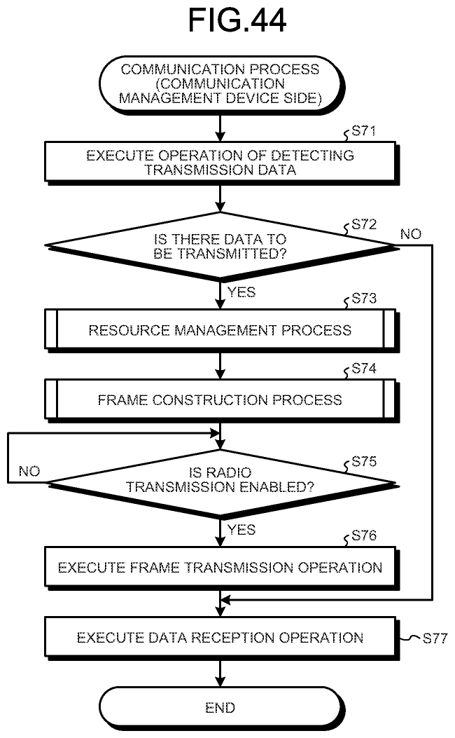

Next, a communication process on the communication management device 10 side will be described. FIG. 44 is a flowchart illustrating an example of a communication process (communication management device side) according to an embodiment of the present disclosure. The communication process is a process related to multi-user multiplex communication (for example, downlink OFDM communication or uplink OFDM communication with the communication device 20) performed by the communication management device 10. The communication process is executed periodically, for example. Hereinafter, the communication process will be described with reference to the flowchart of FIG. 44.

First, the transmission unit 155 of the communication management device 10 executes operation of detecting transmission data to be transmitted to the communication device (step S71). For example, the transmission unit 155 confirms whether there is user data to be transmitted to the storage unit 12. In a case where there is no transmission data (step S72: No), the control unit 15 of the communication management device 10 proceeds to step S77.

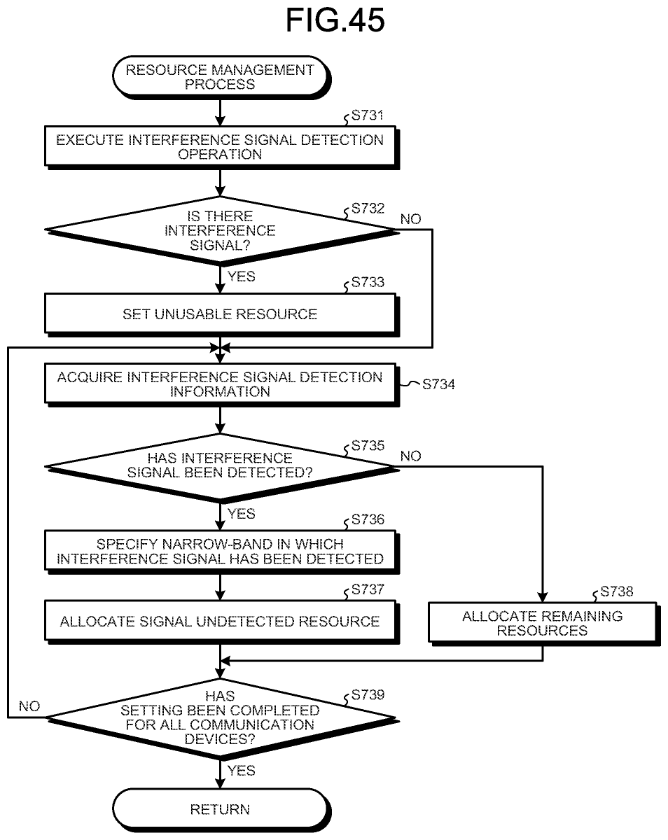

In a case where there is transmission data (step S72: Yes), the control unit 15 (for example, the management unit 153 of the communication management device 10) executes a resource management process (step S73). FIG. 45 is a flowchart illustrating an example of the resource management process according to an embodiment of the present disclosure. The resource management process is a process of managing the radio resources used by the communication device 20 for radio communication based on interference signal detection information. More specifically, the resource management process is a process of managing frequency channels to be radio resources in units of narrow bandwidth.

First, the detection unit 152 of the communication management device 10 detects an interference signal using the narrow bandwidth as units of detection (step 731). That is, the detection unit 152 detects whether the communication management device 10 itself has interference from other systems. The method for detecting the interference signal may be the method similar to the method illustrated in the narrow-band signal detection process of FIG. 40. For example, the detection unit 152 operates a narrow-band signal detection unit (for example, the radio communication unit 11) to grasp the presence of another system transmitting the signal. Subsequently, the detection unit 152 converts the detected signal into the granularity of the resource unit. For example, the detection unit 152 determines the detection signal corresponds to which narrow-band among a plurality of predetermined narrow-bands (narrow-bands corresponding to resource units) located in the frequency direction. Subsequently, the detection unit 152 records the determined narrow-band in the storage unit 12 as a narrow-band (resource unit) in which the interference signal has been detected. Information related to the narrow-band (resource unit) in which the interference signal has been detected will be the interference signal detection information (detection result).

Subsequently, the acquisition unit 151 of the communication management device 10 acquires interference signal detection information from the storage unit 12. Subsequently, the management unit 153 determines whether there is an interference signal from another system based on the detection information (step S732). In a case where there is no interference signal (step S732: No), the management unit 153 proceeds to step S734.

In a case where there is an interference signal (step S732: Yes), the management unit 153 specifies a narrow-band having the interference signal among the frequency channels used by the communication management device 10 based on the detection information. Subsequently, the management unit 153 manages the specified narrow-band as a resource unit that is unusable by the communication device 20 within its own radio communication range. For example, the management unit 153 manages the specified narrow-band as an unusable band for radio communication by all the communication devices 20 under control. For example, the management unit 153 sets the resource unit belonging to the specified narrow-band to radio resource management data as an unusable resource for communication with the communication device 20 (step S733). The management data may be scheduling data for allocation of radio resources (resource units), for example.

Subsequently, the acquisition unit 151 of the communication management device 10 selects the communication device 20 that has not yet executed the processes of steps S734 to S739 below among the plurality of communication devices 20 (for example, the communication devices 20 that is needed for communication). Hereinafter, the communication device 20 selected here is referred to as a predetermined communication device 20. Subsequently, the acquisition unit 151 acquires interference signal detection information from the predetermined communication device 20 (step S734). At this time, the acquisition unit 151 may execute the reporting receipt process of FIG. 42 to acquire the interference signal detection information. Subsequently, based on the detection information, the management unit 153 determines whether the predetermined communication device 20 has detected an interference signal from another system (step S735).

In a case where the interference signal has been detected (step S735: Yes), the management unit 153 specifies a narrow-band having an interference signal to the predetermined communication device 20 based on the detection information regarding the predetermined communication device 20 (step S736). Subsequently, the management unit 153 manages the specified narrow-band as a band that the predetermined communication device 20 cannot use for radio communication. For example, the management unit 153 sets a resource unit belonging to the specified narrow-band as an unusable resource unit for communication with the predetermined communication device 20.

Subsequently, the management unit 153 allocates an interference signal undetected resource to the communication with the predetermined communication device 20 (step S737). Here, the signal undetected resource is, for example, a resource unit belonging to a narrow-band in which no interference signal has been detected in both the predetermined communication device 20 and the communication management device 10. At this time, the management unit 153 may allocate a signal undetected resource to the predetermined communication device 20 in preference to the communication device 20 that has not detected the interference signal. For example, in a case where the signal undetected resource is not yet allocated to the other communication device 20, the management unit 153 allocates a signal undetected resource allocated to the other communication device 20 that has not detected the interference signal, to the predetermined communication device 20. At this time, a resource unit in which a predetermined communication device 20 has detected an interference signal may be allocated to the other communication device 20. This would achieve effective use of radio resources.

In a case where the predetermined communication device 20 has not detected the interference signal (step S735: No), the management unit 153 allocates a part or all of the remaining resources to the communication with the predetermined communication device 20 (step S738). The remaining resource is the remaining radio resource (for example, resource unit) that has not yet been allocated. Note that a resource unit in which another communication device 20 has detected an interference signal, among the remaining resources, may be allocated to the predetermined communication device 20. This would achieve effective use of radio resources.

Subsequently, the management unit 153 determines whether the radio resource settings have been completed for all of the plurality of communication devices 20 (step S739). In a case where the setting is not completed (step S739: No), the management unit 153 returns the process to step S734. In a case where the setting is completed (step S739: Yes), the management unit 153 returns the process to the communication process illustrated in FIG. 44.

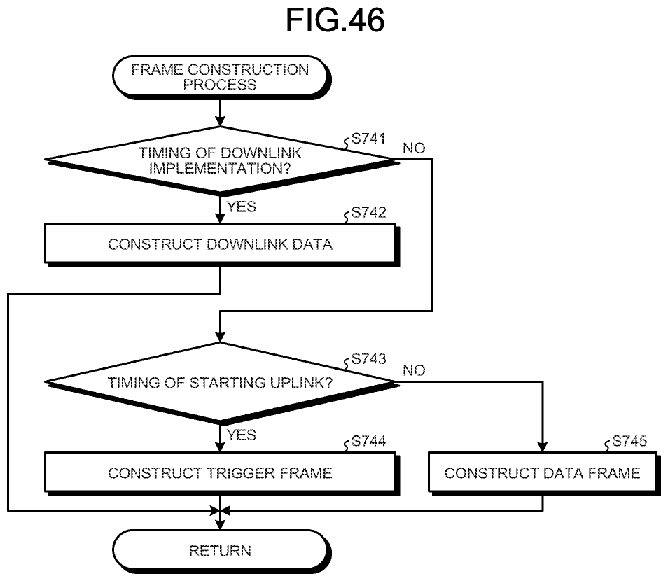

Subsequently, the construction unit 154 of the communication management device 10 executes a frame construction process (step S74). FIG. 46 is a flowchart illustrating an example of the frame construction process according to an embodiment of the present disclosure. The frame construction process is a process of constructing a frame to be transmitted to the communication device 20.

First, the construction unit 154 determines whether the timing of implementation of the downlink (for example, downlink OFDM communication with the communication device 20) has arrived (step S741). In the case of downlink implementation timing (step S741: Yes), downlink data (for example, downlink OFDM data frame) is constructed in accordance with the resource unit allocation (step S742). When the construction of the downlink data is completed, the construction unit 154 returns the process to the communication process of FIG. 44.

In a case where it is not the downlink implementation timing (step S741: No), the construction unit 154 determines whether the timing of starting the uplink (for example, uplink OFDM communication with the communication device 20) has arrived (step S743). In the case of the uplink start timing (step S743: Yes), a trigger frame is constructed in accordance with the resource unit allocation (step S744). In a case where it is not the uplink start timing (step S743: No), or in a case where it is not necessary to perform multi-user multiplexing, the construction unit 154 constructs an ordinary data frame (step S745). When the frame construction is completed, the construction unit 154 returns the process to the communication process.

Returning to the flow of FIG. 44, the transmission unit 155 of the communication management device 10 determines whether radio transmission is enabled (step S75). For example, the transmission unit 155 determines whether a predetermined access control waiting time has elapsed. In a case where radio transmission is not possible (step S75: No), the transmission unit 155 repeats step S75 until radio transmission is enabled. In a case where radio transmission is possible (step S75: Yes), the transmission unit 155 executes (step S76) the transmission operation of the frame generated in step S74. For example, the transmission unit 155 controls the transmission processing unit 112 of the radio communication unit 11 to transmit the frame.

Subsequently, the acquisition unit 151 of the communication management device 10 executes the frame reception operation (step S77). For example, the acquisition unit 151 controls the reception processing unit 111 of the radio communication unit 11 to receive the frame. When the reception of the frame is completed, the control unit 15 ends the communication process.

<7-4. Communication Process (Communication Device Side)>

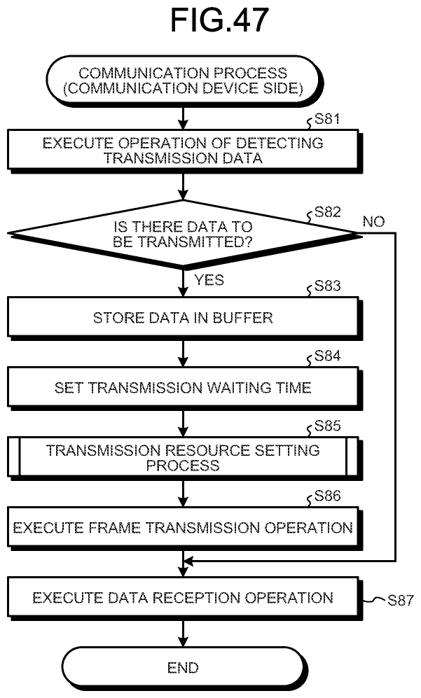

Next, a communication process on the communication management device 10 side will be described. FIG. 47 is a flowchart illustrating an example of a communication process (communication device side) according to an embodiment of the present disclosure. The communication process is a process related to multi-user multiplex communication (for example, downlink OFDM communication or uplink OFDM communication with the communication management device 10) of the communication device 20. The communication process is periodically executed by the communication unit 253 of the communication device 20, for example. Hereinafter, the communication process will be described with reference to the flowchart of FIG. 47.

First, the communication unit 253 executes an operation of detecting transmission data to be transmitted to the communication management device 10 (step S81). For example, the communication unit 253 confirms whether there is user data to be transmitted to the storage unit 22. Furthermore, the transmission data may be the interference signal detection result (detection information). In a case where there is no transmission data (step S82: No), the communication unit 253 proceeds to step S87.

In a case where there is transmission data (step S82: Yes), the communication unit 253 stores the transmission data in a transmission buffer (step S83). The transmission buffer may be the storage unit 22 or the memory included in the radio communication unit 21. Subsequently, the communication unit 253 sets the transmission waiting time as a back-off period in accordance with the type (access category) of the transmission data (step S84).

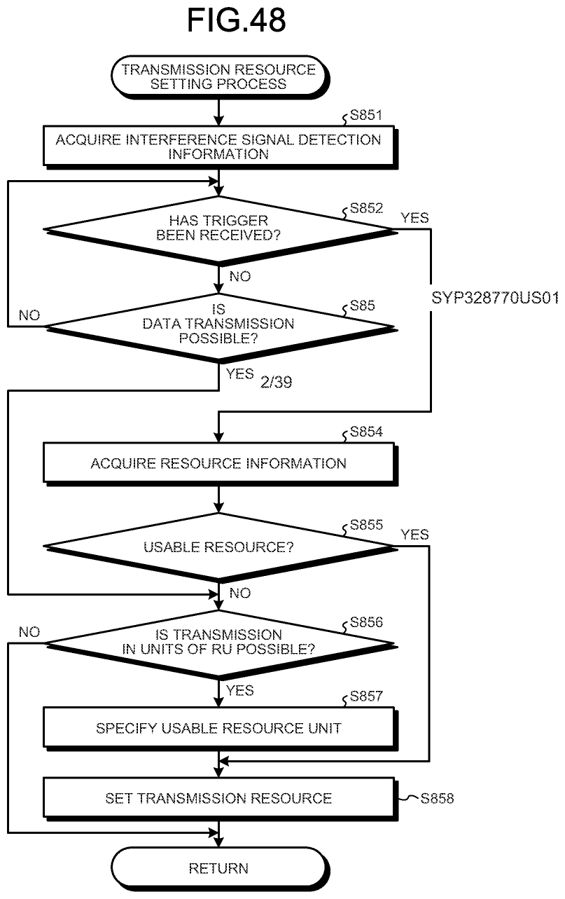

Subsequently, the control unit 25 (for example, the communication unit 253) of the communication device 20 executes a transmission resource setting process (step S85). FIG. 48 is a flowchart illustrating an example of the transmission resource setting process according to an embodiment of the present disclosure. The transmission/reception resource setting process is a process of setting a transmission resource (radio resource) to be used for communication with the communication management device 10.

First, the acquisition unit 251 of the communication device 20 acquires interference signal detection information (step S851). The detection information may be an interference signal detection result acquired by the narrow-band signal detection process illustrated in FIG. 40. For example, the acquisition unit 251 acquires the information of the resource unit that has detected the narrow-band signal (interference signal).

Subsequently, the communication unit 253 determines whether the trigger frame has been received from the communication management device 10 (step S852). In a case where the trigger frame has not been received (step S852: No), the communication unit 253 determines whether data reception is possible (step S853). In a case where the data reception is not possible (step S853: No), the communication unit 253 returns the process to step S852. In a case where the data reception is possible (step S853: Yes), the communication unit 253 proceeds to step S856.

In a case where the trigger frame has been received (step S852: No), the acquisition unit 251 acquires information of the radio resource to be used by the communication device 20 for communication (step S854). For example, the acquisition unit 251 acquires information of the resource unit (hereinafter, referred to as the allocation resource unit) described in the trigger frame.

Subsequently, the communication unit 253 determines whether the allocation resource unit is a usable radio resource (step S855). For example, based on the detection information acquired in step S851, the communication unit 253 determines whether the allocation resource unit is a resource unit in which a narrow-band signal (interference signal) has been detected. In a case where the allocation resource unit is a usable radio resource (step S855: Yes), the communication unit 253 proceeds to step S858.

In a case where the allocation resource unit is not a usable radio resource (step S855: No), the communication unit 253 determines whether transmission in units of resource unit (RU) is possible (step S856). In a case where transmission in units of resource unit is not possible (step S856: No), the communication unit 253 returns the process to the communication process illustrated in FIG. 47.

In a case where transmission in units of resource unit is possible (step S856: Yes), the communication unit 253 specifies a resource unit that can be transmitted (step S857). Subsequently, the communication unit 253 sets the allocation resource unit or the resource unit specified in step S857 as a resource unit to be used by the communication device 20 for communication (step S858). When the setting is completed, the communication unit 253 returns the process to the communication process.

Returning to the flow of FIG. 47, the transmission unit 255 of the communication device 20 executes operation of transmitting the transmission data (transmission data frame) (step S86). For example, the transmission unit 255 controls the transmission processing unit 212 of the radio communication unit 21 to transmit a frame. At this time, the transmission unit 255 transmits a frame using the resource unit set in step S858. In a case where it is determined in step S856 that transmission is not possible in units of resource unit, the transmission data would be transmitted by radio transmission, using, out of necessity, a predetermined radio resource (for example, an allocation resource unit).

Subsequently, the reception unit 254 of the communication device 20 performs a frame reception operation (step S87). For example, the reception unit 254 controls the reception processing unit 211 of the radio communication unit 21 to receive a frame. The frame received by the reception unit 254 may be a trigger frame or a data frame. Furthermore, the frame received by the reception unit 254 may be a report request frame. When the reception of the frame is completed, the control unit 25 ends the communication process. In a case where the frame received by the reception unit 254 is a report request frame, the control unit 25 may execute the processes illustrated in FIGS. 40 and 41 to transmit the report frame to the communication management device 10.

### 8. Modifications

The above-described embodiment is an example, and various modifications and applications are possible.

<8-1. Modifications of the Configuration of the Communication Management Device>

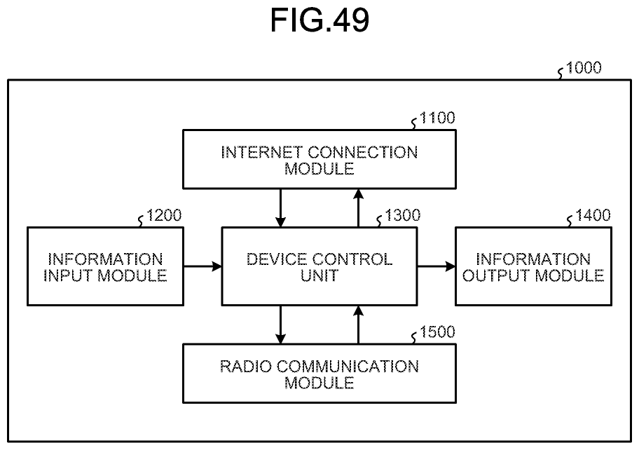

FIG. 49 is a diagram illustrating a device configuration example of an information processing device 1000 which is an example of a communication management device according to an embodiment of the present disclosure. The device configuration illustrated in FIG. 49 can be applied not only to the communication management devices 10 and 30, but also to the communication devices 20 and 40. In the example of FIG. 49, the information processing device 1000, which is a position example of the communication management device, includes: an Internet connection module 1100; an information input module 1200; a device control unit 1300; an information output module 1400; and a radio communication module 1500. The information processing device 1000 may include only the modules needed for each of the communication devices. Unnecessary parts may be simplified or omitted.

The Internet connection module 1100 is equipped with a function such as a communication modem for connecting to the Internet in a case where the information processing device 1000 operates as an access point.

The information input module 1200 is a component used for inputting information transmitting an instruction from a user. The information input module 1200 may include a push button, a keyboard, and a touch panel, for example.

The device control unit 1300 is a component that functions as a control unit of the communication management device (or communication device) of the present embodiment. The device control unit 1300 operates the communication device intended by the user as an access point. The device control unit 1300 has functions as the control units 15 and 25.

The information output module 1400 is a component that specifically displays the operating state of the communication device and the information obtained via the Internet. The information output module 1400 is, for example, a display device such as an LED, a liquid crystal panel, or an organic EL display. The information output module 1400 displays information to the user.

The radio communication module 1500 is a component that processes radio communication. The radio communication module 1500 has functions as radio communication units 11 and 21, and control units 15 and 25.

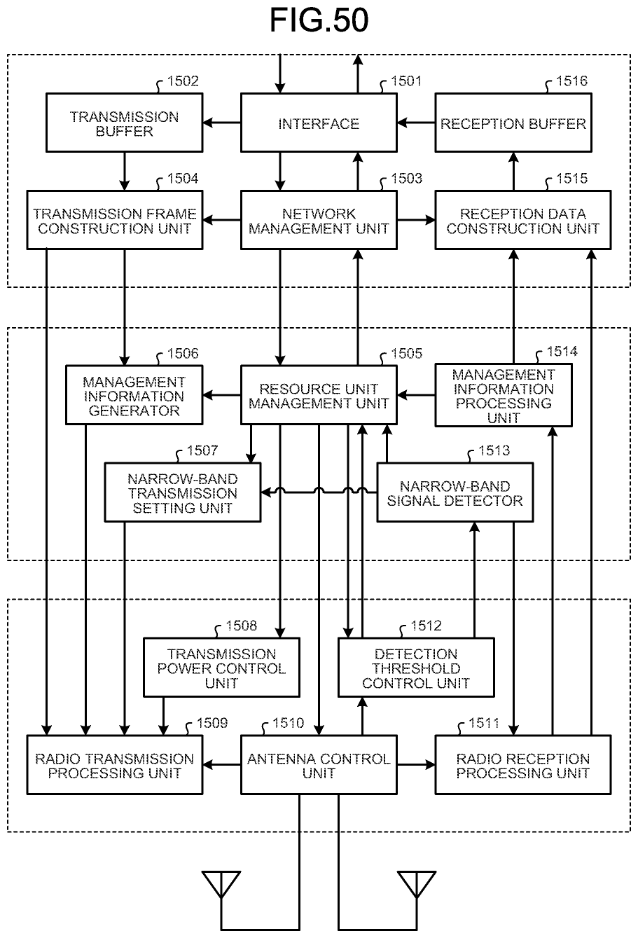

FIG. 50 is a diagram illustrating a functional configuration of the information processing device 1000 according to an embodiment of the present disclosure. FIG. 50 illustrates a functional block diagram of the radio communication module 1500 as a functional configuration of the information processing device 1000. The functional configuration illustrated in FIG. 50 can be applied not only to the communication management devices 10 and 30, but also to the communication devices 20 and 40.

The radio communication module 1500 includes: an interface 1501; a transmission buffer 1502; a network management unit 1503; a transmission frame construction unit 1504; a resource unit management unit 1505; a management information generator 1506; a narrow-band transmission setting unit 1507; a transmission power control unit 1508; radio transmission processing unit 1509; an antenna control unit 1510; a radio reception processing unit 1511; a detection threshold control unit 1512; a narrow-band signal detector 1513; a management information processing unit 1514; a reception data construction unit 1515; and a reception buffer 1516.

The interface 1501 functions as an interface for exchanging input from the user, data from the Internet network, and information addressed to the user in a predetermined signal format. The interface 1501 corresponds to the network communication units 13 and 23, for example.

The transmission buffer 1502 is a buffer that temporarily stores an input from a user or a signal to be sent in radio transmission when received. The transmission buffer 1502 corresponds to the storage units 12 and 22, for example.

The network management unit 1503 manages address information or the like of the communication device included in a radio network. In addition, the network management unit 1503 makes an Internet connection when it is operating as a communication device operating as an access controller or an Internet gateway.

The transmission frame construction unit 1504 is a section that converts radio transmission data into a data frame for radio transmission. The transmission buffer 1502 corresponds to the construction unit 154 or the communication unit 253, for example.

In a case where a communication device has detected a narrow-band signal, the resource unit management unit 1505 manages the signal in association with the resource unit. Subsequently, the resource unit management unit 1505 manages the resource units capable of own communication. In addition, the resource unit management unit 1505 manages information regarding resource units usable by the communication device. The resource unit management unit 1505 corresponds to the management unit 153 and the transmission unit 155, for example.

The management information generator 1506 is a section that generates a report request frame, a report frame, a beacon signal, and a trigger frame that are actually transmitted in radio transmission. The management information generator 1506 corresponds to the construction unit 154, the transmission units 155 and 255, for example.

The narrow-band transmission setting unit 1507 is a section that constructs a frame to be transmitted in predetermined units of the resource unit and that sets a resource unit to be used for transmission in units of subcarrier. The management information generator 1506 corresponds to the construction unit 154, the transmission units 155 and 255, for example.

The transmission power control unit 1508 is a section that controls the transmission power so that the signal would not reach an unnecessary radio wave reception range when transmitting a predetermined frame. In application of multi-user multiplex communication, the transmission power control unit 1508 has a function of controlling to adjust the minimum necessary transmission power so that the signal will reach the receiving side with an intended received signal strength in data transmission. The management information generator 1506 corresponds to the transmission units 155 and 255, for example.

The radio transmission processing unit 1509 is a section that converts a frame to be sent in radio transmission into a baseband signal and processes the converted signal as an analog signal. The radio transmission processing unit 1509 corresponds to the transmission processing unit 112, for example.

The antenna control unit 1510 is connected to a plurality of antenna elements and controls both radio transmission of signals and signal reception. The antenna control unit 1510 corresponds to the radio communication unit 11, for example.

The radio reception processing unit 1511 is a section that performs a reception process on a header and a data portion to be added after a predetermined preamble in a case where the preamble signal has been detected. The radio reception processing unit 1511 corresponds to the reception processing unit 111, for example.

In a case where the transmission power control is performed, the detection threshold control unit 1512 sets a signal detection level that allows detection of the signal from a communication device present in the reception range. The detection threshold control unit 1512 includes a function of controlling to enable signal detection with the minimum necessary detection threshold in application of spatial reuse technologies. The detection threshold control unit 1512 corresponds to the reception processing unit 111, for example.

The narrow-band signal detector 1513 detects a narrow-band signal. The narrow-band signal detector 1513 includes a function of grasping that the transmission line is used while adapting the narrow-band signal to predetermined units of the resource unit. The narrow-band signal detector 1513 corresponds to the detection units 152 and 252, for example.

The management information processing unit 1514 is a section that analyzes a beacon signal and a trigger frame actually transmitted via radio transmission and extracts parameters in a case where the own device is designated. The management information processing unit 1514 corresponds to the acquisition units 151 and 251, for example.

The reception data construction unit 1515 is a section that removes predetermined header information from the received data frame and extracts necessary data portions. The reception data construction unit 1515 corresponds to the acquisition units 151 and 251 or the reception unit 254, for example.

The reception buffer 1516 is a buffer for temporarily storing the extracted data portion. The reception buffer 1516 corresponds to the storage units 12 and 22, for example.

<8-2. Other Modifications>

The control device that controls the communication management device 10, the communication device 20, the communication management device 30, the communication device 40, or the information processing device 1000 according to the present embodiment may be implemented by a dedicated computer system or a general-purpose computer system.

For example, a communication program for executing the above-described operations (for example, the communication control process, the adjustment process, and the distribution process) is stored in a computer-readable recording medium such as an optical disk, semiconductor memory, a magnetic tape, or a flexible disk and distributed. For example, the program is installed on a computer and the above processes are executed to achieve the configuration of the control device. At this time, the control device may be provided as a device (such as a personal computer) outside the communication management device 10, the communication device 20, the communication management device 30, the communication device 40, or the information processing device 1000. Alternatively, the control device may be an internal device (for example, the control unit 15, the control unit 25, the device control unit 1300, or the radio communication module 1500) provided inside the communication management device 10, the communication device 20, the communication management device 30, the communication device 40, or the information processing device 1000.

Furthermore, the communication program may be stored in a disk device included in a server device on a network such as the Internet so as to be able to be downloaded to a computer, for example. Furthermore, the functions described above may be implemented by using operating system (OS) and application software in cooperation. In this case, the sections other than the OS may be stored in a medium for distribution, or the sections other than the OS may be stored in a server device so as to be downloaded to a computer, for example.

Furthermore, among individual processes described in the above embodiments, all or a part of the processes described as being performed automatically may be manually performed, or the processes described as being performed manually can be performed automatically by known methods. In addition, the processing procedures, specific names, and information including various data and parameters illustrated in the above documents or drawings can be arbitrarily changed unless otherwise specified. For example, various information illustrated in each of drawings is not limited to the information illustrated.

In addition, each of components of each of devices is provided as a functional and conceptional illustration and thus does not necessarily need to be physically configured as illustrated. That is, the specific form of distribution/integration of each of devices is not limited to those illustrated in the drawings, and all or a part thereof may be functionally or physically distributed or integrated into arbitrary units according to various loads and use conditions.

Furthermore, the above-described embodiments and modifications can be appropriately combined within a range implementable without contradiction of processes. Furthermore, the order of individual steps illustrated in the sequence diagram or the flowchart of the present embodiment can be changed as appropriate.

### 9. Conclusion

As described above, according to an embodiment of the present disclosure, the communication management device 10 acquires interference signal detection information with narrow bandwidth as units of detection. Subsequently, the communication management device 10 manages the frequency channel in units of narrow bandwidth based on the detected information. Therefore, the communication management device 10 can grasp the presence of other systems that use the narrow-band signals. More specifically, the communication management device 10 can detect the OFDMA communication used in the OBSS that overlaps and exists around its own BSS. By avoiding the narrow-band used, the communication system 1 can effectively use the radio resources.

In particular, when the communication system 1 is a contention-method communication system such as a wireless LAN system, the frequency band (predetermined frequency band) used for communication is not managed by a central device, leading to a possibility that the radio resources are not regularly used in units of frequency channel. Fortunately however, the communication management device 10 can grasp the presence of interference signals emitted by other systems in units of narrow bandwidth, making it possible to effectively utilize radio resources even in a case where the communication system 1 is a contention-method communication system.

Furthermore, when the communication device 20 is capable of performing radio communication in communication units of narrow bandwidth resource unit, the communication management device 10 can allocate radio resources to the communication device 20 in units of narrow bandwidth. Therefore, even in a case where a narrow bandwidth interference signal is detected in the frequency channel, the communication management device 10 can avoid the interference signal and allocate the remaining band of the frequency channel for communication with the communication device 20. As a result, the communication system 1 can effectively use the radio resources.

Furthermore, the communication management device 10 is configured to perform autonomous detection of interference signals. Therefore, the communication management device 10 can grasp the available resource units autonomously. As a result, the communication system 1 can effectively use the radio resources.

Furthermore, the communication management device 10 acquires the interference signal detection result obtained by the communication device 20 as detection information. Therefore, through the communication device 20, the communication management device 10 can grasp the presence of the interference signal that cannot be directly grasped. Furthermore, the communication management device 10 can specify a resource unit that is difficult to use due to the influence of other systems, for each of the communication devices 20. By avoiding the specified resource unit, the communication system 1 can use the radio resources extremely effectively.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiment and a modification as appropriate.

The effects described in individual embodiments of the present specification are merely examples, and thus, there may be other effects, not limited to the exemplified effects.

Note that the present technology can also have the following configurations.

(1)

A communication management device comprising: an acquisition unit that acquires interference signal detection information with a narrow bandwidth narrower than a channel width defined in a predetermined frequency band, as a unit of detection; and

a management unit that manages, in units of narrow bandwidth, one or more frequency channels included in the predetermined frequency band as radio resources to be used by one or more communication devices for radio communication, based on the detection information.

(2)

The communication management device according to (1),

wherein the management unit manages the one or more frequency channels acquired by a contention method, in units of narrow bandwidth, as radio resources to be used by the one or more communication devices under control for radio communication.

(3)

The communication management device according to (1) or (2),

wherein the management unit specifies a narrow-band having an interference signal among the one or more frequency channels based on the detection information, and manages the specified narrow-band as a band that is unusable for radio communication by the communication device.

(4)

The communication management device according to any one of (1) to (3),

in which the communication device is capable of performing radio communication using the narrow bandwidth resource unit as a unit of communication, and

the management unit specifies a narrow-band having an interference signal among the one or more frequency channels based on the detection information, and manages the resource unit belonging to the specified narrow-band as a resource unit that is unusable for radio communication by the communication device.

(5)

The communication management device according to any one of (1) to (4), further comprising

a detection unit that detects an interference signal with the narrow bandwidth as a unit of detection,

wherein the acquisition unit acquires a detection result obtained by the detection unit, as the detection information.

(6)

The communication management device according to (5), in which the communication device is capable of performing radio communication using the narrow bandwidth resource unit as a unit of communication, and

the management unit specifies a narrow-band having an interference signal among the one or more frequency channels based on a detection result obtained by the detection unit, and manages the resource unit belonging to the specified narrow-band as a resource unit that is unusable for radio communication by the communication device in an own radio communication range.

(7)

The communication management device according to any one of (1) to (6),

wherein the communication device is capable of detecting an interference signal with the narrow bandwidth as a unit of detection, and

the acquisition unit acquires an interference signal detection result obtained by the communication device, as the detection information.

(8)

The communication management device according to (7),

wherein the communication device is capable of performing radio communication with the narrow bandwidth resource unit as a unit of communication, and

the management unit specifies a narrow-band having an interference signal among the one or more frequency channels based on the detection result, and manages the resource unit belonging to the specified narrow-band as a resource unit that is unusable for radio communication by a predetermined communication device.

(9)

The communication management device according to (8),

wherein the management unit allocates the resource unit belonging to the specified narrow-band to another communication device among the one or more communication devices, without allocating the resource unit to the predetermined communication device.

(10)

The communication management device according to any one of (7) to (9), further comprising

a transmission unit that transmits a transmission request for an interference signal detection result to the communication device,

wherein the acquisition unit acquires the detection result transmitted by the communication device in response to the transmission request, as interference signal detection information.

(11)

The communication management device according to (10),

wherein the transmission unit transmits, to one of the one or more communication devices, the transmission request by using two or more narrow-bands among a plurality of narrow-bands included in the one or more frequency channels.

(12)

The communication management device according to (11),

wherein the acquisition unit monitors transmission of the detection result of the communication device for the two or more narrow-bands.

(13)

The communication management device according to any one of (1) to (12), further comprising

a transmission unit that transmits data to the communication device,

wherein the management unit sets a specific resource unit that the communication device can use for radio communication, and

the transmission unit transmits data based on a predetermined access control method.

(14)

The communication management device according to any one of (1) to (13),

wherein the channel width is a channel width defined by a predetermined communication method that defines radio communication using orthogonal frequency multiple access, and

the narrow bandwidth is a bandwidth corresponding to a predetermined number of subcarrier spacings defined by the predetermined communication method.

(15)

The communication management device according to (14),

wherein the predetermined communication method is a wireless LAN communication method.

(16)

A communication device comprising:

a detection unit that detects an interference signal with a narrow bandwidth narrower than a channel width defined in a predetermined frequency band, as a unit of detection; and

a transmission unit that transmits interference signal detection information to a communication management device that manages, in units of narrow bandwidth, one or more frequency channels included in the predetermined frequency band as radio resources to be allocated to radio communication with one or more communication devices.

(17)

The communication device according to (16), further comprising:

an acquisition unit that acquires, from the communication management device, information regarding radio resources to be used for radio communication with the communication management device; and

a communication unit that executes radio communication with a narrow bandwidth resource unit as a unit of communication,

wherein the information regarding the radio resource acquired by the acquisition unit from the communication management device is information regarding a resource unit allocated by the communication management device, and

the communication unit performs radio communication with the communication management device by using the resource unit allocated by the communication management device.

(18)

The communication device according to (16) or (17), further comprising

a reception unit that receives a transmission request for interference signal detection information from the communication management device,

wherein, in a case where the reception unit has received the transmission request, the transmission unit transmits interference signal detection information to the communication management device.

(19)

The communication device according to (18),

wherein, in a case where the reception unit has received a transmission request from the communication management device in two or more narrow-bands among a plurality of narrow-bands included in the one or more frequency channels, the transmission unit transmits the detection information by using a narrow-band in which no interference signal has been detected, among the two or more narrow-bands.

(20)

The communication device according to any one of (16) to (19),

wherein the channel width is a channel width defined by a wireless LAN communication method, and

the narrow bandwidth is a bandwidth corresponding to a predetermined number of subcarrier spacings defined by the wireless LAN communication method.

(21)

A communication management method comprising:

acquiring interference signal detection information with a narrow bandwidth narrower than a channel width defined in a predetermined frequency band, as a unit of detection; and

managing, in units of narrow bandwidth, one or more frequency channels included in the predetermined frequency band as radio resources to be allocated to radio communication with one or more communication devices, based on the detection information.

(22)

A communication method comprising:

detecting an interference signal with a narrow bandwidth narrower than a channel width defined in a predetermined frequency band, as a unit of detection; and

transmitting interference signal detection information to a communication management device that manages, in units of narrow bandwidth, one or more frequency channels included in the predetermined frequency band as radio resources to be allocated to radio communication with one or more communication devices.

### REFERENCE SIGNS LIST

1, 2 COMMUNICATION SYSTEM
10, 30 COMMUNICATION MANAGEMENT DEVICE
20, 40 COMMUNICATION DEVICE
11, 21 RADIO COMMUNICATION UNIT
12, 22 STORAGE UNIT
13, 23 NETWORK COMMUNICATION UNIT
14, 24 INPUT/OUTPUT UNIT
15, 25 CONTROL UNIT
111, 211 RECEPTION PROCESSING UNIT
112, 212 TRANSMISSION PROCESSING UNIT
151, 251 ACQUISITION UNIT
152, 252 DETECTION UNIT
153 MANAGEMENT UNIT
154 CONSTRUCTION UNIT
155, 255 TRANSMISSION UNIT
253 COMMUNICATION UNIT
254 RECEIVING UNIT

1. A communication management device comprising:
an acquisition unit that acquires interference signal detection information with a narrow bandwidth narrower than a channel width defined in a predetermined frequency band, as a unit of detection; and
a management unit that manages, in units of narrow bandwidth, one or more frequency channels included in the predetermined frequency band as radio resources to be used by one or more communication devices for radio communication, based on the detection information.

2. The communication management device according to claim 1,
wherein the management unit manages the one or more frequency channels acquired by a contention method, in units of narrow bandwidth, as radio resources to be used by the one or more communication devices under control for radio communication.

3. The communication management device according to claim 1, further comprising
a detection unit that detects an interference signal with the narrow bandwidth as a unit of detection,
wherein the acquisition unit acquires a detection result obtained by the detection unit, as the detection information.

4. The communication management device according to claim 1,
wherein the management unit specifies a narrow-band having an interference signal among the one or more frequency channels based on the detection information, and manages the specified narrow-band as a band that is unusable for radio communication by the communication device.

5. The communication management device according to claim 1,
wherein the communication device is capable of detecting an interference signal with the narrow bandwidth as a unit of detection, and
the acquisition unit acquires an interference signal detection result obtained by the communication device, as the detection information.

6. The communication management device according to claim 5,
wherein the communication device is capable of performing radio communication with the narrow bandwidth resource unit as a unit of communication, and
the management unit specifies a narrow-band having an interference signal among the one or more frequency channels based on the detection result, and manages the resource unit belonging to the specified narrow-band as a resource unit that is unusable for radio communication by a predetermined communication device.

7. The communication management device according to claim 6,
wherein the management unit allocates the resource unit belonging to the specified narrow-band to another communication device among the one or more communication devices, without allocating the resource unit to the predetermined communication device.

8. The communication management device according to claim 5, further comprising
a transmission unit that transmits a transmission request for an interference signal detection result to the communication device,
wherein the acquisition unit acquires the detection result transmitted by the communication device in response to the transmission request, as interference signal detection information.

9. The communication management device according to claim 8,
wherein the transmission unit transmits, to one of the one or more communication devices, the transmission request by using two or more narrow-bands among a plurality of narrow-bands included in the one or more frequency channels.

10. The communication management device according to claim 9,
wherein the acquisition unit monitors transmission of the detection result of the communication device for the two or more narrow-bands.

11. The communication management device according to claim 1, further comprising
a transmission unit that transmits data to the communication device,
wherein the management unit sets a specific resource unit that the communication device can use for radio communication, and
the transmission unit transmits data based on a predetermined access control method.

12. The communication management device according to claim 1,
wherein the channel width is a channel width defined by a predetermined communication method that defines radio communication using orthogonal frequency multiple access, and
the narrow bandwidth is a bandwidth corresponding to a predetermined number of subcarrier spacings defined by the predetermined communication method.

13. The communication management device according to claim 12,
wherein the predetermined communication method is a wireless LAN communication method.

14. A communication device comprising:
a detection unit that detects an interference signal with a narrow bandwidth narrower than a channel width defined in a predetermined frequency band, as a unit of detection; and
a transmission unit that transmits interference signal detection information to a communication management device that manages, in units of narrow bandwidth, one or more frequency channels included in the predetermined frequency band as radio resources to be allocated to radio communication with one or more communication devices.

15. The communication device according to claim 14, further comprising:
an acquisition unit that acquires, from the communication management device, information regarding radio resources to be used for radio communication with the communication management device; and
a communication unit that executes radio communication with a narrow bandwidth resource unit as a unit of communication,
wherein the information regarding the radio resource acquired by the acquisition unit from the communication management device is information regarding a resource unit allocated by the communication management device, and
the communication unit performs radio communication with the communication management device by using the resource unit allocated by the communication management device.

16. The communication device according to claim 14, further comprising
a reception unit that receives a transmission request for interference signal detection information from the communication management device,
wherein, in a case where the reception unit has received the transmission request, the transmission unit transmits interference signal detection information to the communication management device.

17. The communication device according to claim 16,
wherein, in a case where the reception unit has received a transmission request from the communication management device in two or more narrow-bands among a plurality of narrow-bands included in the one or more frequency channels, the transmission unit transmits the detection information by using a narrow-band in which no interference signal has been detected, among the two or more narrow-bands.

18. The communication device according to claim 14,
wherein the channel width is a channel width defined by a wireless LAN communication method, and
the narrow bandwidth is a bandwidth corresponding to a predetermined number of subcarrier spacings defined by the wireless LAN communication method.

19. A communication management method comprising:
acquiring interference signal detection information with a narrow bandwidth narrower than a channel width defined in a predetermined frequency band, as a unit of detection; and
managing, in units of narrow bandwidth, one or more frequency channels included in the predetermined frequency band as radio resources to be allocated to radio communication with one or more communication devices, based on the detection information.

20. A communication method comprising:
detecting an interference signal with a narrow bandwidth narrower than a channel width defined in a predetermined frequency band, as a unit of detection; and
transmitting interference signal detection information to a communication management device that manages, in units of narrow bandwidth, one or more frequency channels included in the predetermined frequency band as radio resources to be allocated to radio communication with one or more communication devices.
